(19) United States
(12) Patent Application Publication
(10) Pub. No.: US 2026/0336144 A1
(43) Pub. Date: Oct. 29, 2026

(54) PLANT TRIMMING MACHINES AND METHODS

(71) Applicant: ETEROS TECHNOLOGIES INC., Surrey (CA)

(72) Inventors: Aaron George MCKELLAR, Surrey (CA); Antony PAVICIC, Maple Ridge (CA); Jesse Tyrel GLASSFORD, Richmond (CA); Angel Ramon TORRADO PEREZ, San Diego, CA (US); Ryan James BJERGSO, Carleton Place (CA); Terence Richard LEEFLANG, Perth (CA); Ibrahim Ahmad YOUSSEF, Ottawa (CA); Thomas Blair McGRATH, Merrickville (CA); Keith River TEEPLE, Ottawa (CA); Alex Jeffrey FELDMAN, Vancouver (CA); Ricardo Kenji Vargas KUWABARA, Vancouver (CA)

(21) Appl. No.: 19/122,210

(22) PCT Filed: Oct. 17, 2022
(86) PCT No.: PCT/US22/78232

§ 371 Date: Apr. 17, 2025

(51) Int. Cl. B26D 1/40; A01G 3/00; B26D 1/00; B26D 7/26

(52) U.S. Cl. CPC B26D 1/405; B26D 1/0006; B26D 7/2614; A01G 3/00; B26D 2001/0073

(57) ABSTRACT

A modular plant trimming machine includes a removable trimming module including a tumbler, a cutting reel and a knife. The machine further includes a removable power pack module configured to rotate the tumbler and the cutting reel, and a chassis configured to removably receive and support the removable trimming module in mechanical communication with the removal power pack module. An interconnection system of the plant trimming machine includes a frame connector extending from a frame of the plant trimming machine, and an alignment mechanism adjustable to alter a height of the frame to align the frame connector with a complementary frame connector of an adjacent plant trimming machine.

### FIELD

The present invention relates to apparatus and methods for trimming plant material.

### BACKGROUND

Some types of plant crops are harvested primarily for their flowers or for their pre-flowering buds (embryonic shoots). Examples of such crops include hops (one of the four main ingredients in beer), medical marijuana, or recreational marijuana in jurisdictions where it is legal, for example.

The harvesting of such crops typically includes separating the desirable flowers or buds from undesirable leaf material. Conventionally, this is achieved by causing harvested buds to propagate axially through the inside of a tumbler, which is typically a rotating cylinder formed of sheet metal with slots cut out of it. The axial propagation of the plant material through the tumbler is often gravity-driven, by inclining the axis of the tumbler relative to a horizontal plane, although other ways of axially driving the material are also known. Rotation of the tumbler causes the buds to rotate and tumble while they simultaneously propagate axially through the length of the tumbler. As the tumbler rotates, a vacuum underneath the tumbler applies a suction force, which causes some of the leaves to protrude downward through the slots of the tumbler and into the path of a cutting reel system adjacent the tumbler. The cutting reel system conventionally includes a rotating cutting reel and a rigid planar cutting knife interposed between the reel and the tumbler. The knife is typically a rigid rectangular piece of hard metal with at least one cutting edge. The cutting reel typically includes a cylindrical central shaft that supports multiple helical cutting blades that wind at least partly around the central shaft as they extend across the length of the reel. The vacuum beneath the tumbler tends to pull leaf material downward through the slots in the tumbler, where the leaf material is then cut by the scissor-like action of each helical cutting blade bearing against the cutting edge of the cutting knife as the reel rotates.

The applicant's prior PCT Publication No. WO 2019/079877 A1 discloses numerous innovations in plant trimming technology, including the use of multiple reels per tumbler, a corded tumbler, and a helical-bladed cutting reel with blades welded directly to its shaft, to name but a few examples.

### SUMMARY

In one illustrative embodiment of the present disclosure, a bed knife assembly for a trimming machine includes a knife holder and a knife blade. The knife blade includes a secured portion secured within the knife holder, and a flexible unsecured portion extending outward from the knife holder by a sufficient distance to permit the flexible unsecured portion of the knife blade to flex during operation. The knife blade is pre-loaded with a sufficient pre-load force applied between the bed knife assembly and a helical-bladed cutting reel to deform the knife blade.

Advantageously, the pre-loading tends to force the knife blade to bend, at a plurality of contact points or contact patches between the knife blade and a plurality of helical cutting blades of the cutting reel. This tends to achieve better contact between the knife blade and the helical blades along more of the knife blade's length, effectively creating longer contact patches between the knife blade 2208 and the rotating helical blades 1906 as they spin past the knife blade. This tends to promote more efficient trimming, with a potentially greater amount of undesired plant material removed per cutting reel rotation.

In some embodiments, the flexible unsecured portion of the knife blade may extend outward at least three quarters of an inch from the knife holder. In one such embodiment, the flexible unsecured portion of the knife blade extends about one inch outward from the knife holder. In another illustrative group of embodiments, the flexible unsecured portion of the knife blade extends outward from the knife holder by a distance in the range from three quarters of an inch to two inches. In other illustrative embodiments, the flexible unsecured portion extends at least two inches outward from the knife holder.

Advantageously in such embodiments, the knife blade is more flexible, and tends to maintain better contact with the helical cutting reel blades along even longer contact patches, thereby resulting in further improvements in trimming efficiency.

In another illustrative embodiment, a trimming machine chassis includes a support system configured to support a removable induction assembly module. The support system includes a first rail and a second rail, spaced apart and configured to support first and second opposite ends of the removable induction assembly module resting thereon. The support system further includes at least one induction assembly module retention mechanism configured to operably secure the removable induction assembly module in the chassis. Advantageously, such embodiments greatly facilitate tasks such as cleaning or maintenance of the trimming machine.

In another illustrative embodiment, a plant trimming machine includes a chassis configured to support a tumbler, and further configured to support a cutting reel and a knife assembly adjacent the tumbler. The machine further includes a removable power pack assembly receivable in the chassis and including at least one drive motor for rotating the tumbler and the cutting reel. The at least one drive motor of the removable power pack assembly is biased primarily by gravity to engage with and drive rotation of the tumbler and the cutting reel. Advantageously, such embodiments greatly facilitate cleaning of the trimming machine, since the removable power pack can simply be removed, allowing the remainder of the trimming machine to be pressure washed.

In another illustrative embodiment, an interconnection system of a plant trimming machine includes a frame connector extending from a frame of the plant trimming machine, and an alignment mechanism adjustable to alter a height of the frame to align the frame connector with a complementary frame connector of an adjacent plant trimming machine. Advantageously, such an alignment mechanism facilitates quick and easy vertical alignment of trimming machines connected in tandem.

In another illustrative embodiment, a modular plant trimming machine includes a removable trimming module including a tumbler, a cutting reel and a knife. The machine further includes a removable power pack module configured to rotate the tumbler and the cutting reel, and a chassis configured to removably receive and support the removable trimming module in mechanical communication with the removal power pack module. Advantageously, such a modular machine can be easily dismantled and reassembled within minutes, without the use of tools or specialized knowledge.

Other aspects, features and advantages of illustrative embodiments of the present invention will become apparent to those ordinarily skilled in the art upon review of the following description of such embodiments in conjunction with the accompanying figures.

### BRIEF DESCRIPTION OF THE DRAWINGS

In drawings which illustrate embodiments of the present disclosure,

FIG. 1A is an isometric view (right-top-front) of a plant trimming machine according to a first embodiment of the disclosure;

FIG. 1B is a right side view of the plant trimming machine of FIG. 1A;

FIG. 2A is an isometric view of a main chassis of the plant trimming machine of FIG. 1;

FIG. 2B is a left-back-bottom isometric view of the main chassis of FIG. 2A;

FIG. 3A is an isometric view of a removable trimming module with a removable power pack module of the plant trimming machine of FIG. 1;

FIG. 3B is a right-front view of the removable trimming module of FIG. 3A;

FIG. 3C is a front view of the removable trimming module of FIG. 3A;

FIG. 3D is a rear view of the removable trimming module of FIG. 3A;

FIG. 4A is an isometric view of the removable trimming module of FIG. 3A, with the removable power pack module removed;

FIG. 4B is a bottom-rear-right view of the removable trimming module of FIG. 4A;

FIG. 5 is an isometric view of the removable power pack module shown in FIG. 3A;

FIG. 6A is an isometric view of a removable fan motor module of the plant trimming machine of FIG. 1;

FIG. 6B is a left-rear-bottom view of the removable fan motor module of FIG. 6A;

FIG. 7A is an isometric view of a removable fan blade housing module of the plant trimming machine of FIG. 1;

FIG. 7B is a rear-right-top view of the removable fan blade housing module of FIG. 7A;

FIG. 8A is an isometric view of a removable separator module of the plant trimming machine of FIG. 1;

FIG. 8B is a rear-bottom-left view of the removable separator module of FIG. 8A;

FIG. 9 is an isometric view of the plant trimming machine of FIG. 1 connected in tandem (in series) with another identical plant trimming machine;

FIG. 10A is an isometric view of a plant trimming machine according to a second embodiment of the disclosure, connected in tandem (in series) with a plant trimming machine according to a third embodiment of the disclosure;

FIG. 10B is a right side elevation view of the plant trimming machines in tandem of FIG. 10A;

FIG. 11A is an isometric view of a removable plenum module of one of the plant trimming machines in tandem of FIGS. 10A-B;

FIG. 11B is an isometric view of an alternative removable plenum module of FIGS. 10A-10B, shown with an adjustable airflow choke mechanism;

FIG. 11C is an isometric view of an adjustable airflow baffle of the adjustable airflow choke mechanism of FIG. 11B;

FIG. 12A is a right elevation view of a rail of the main chassis of FIGS. 2A-2B;

FIG. 12B is a front elevation view of the rail of FIG. 12A;

FIG. 13A is an isometric view of a corner joint of the main chassis of FIGS. 2A-2B, shown with an adapter attached;

FIG. 13B is an isometric view of the corner joint of FIG. 13A, shown with the adapter removed;

FIG. 13C is a left elevation view of the corner joint of FIG. 13A;

FIG. 14 is an isometric view of a first upper crossbar of the chassis of FIG. 2A;

FIG. 15 is a left upper rear view of a third upper crossbar of the chassis of FIG. 2A;

FIG. 16A is a left bottom rear view of a jack system of the chassis of FIG. 2A;

FIG. 16B is an isometric view of the jack system of FIG. 16A shown with a cover and a brace depicted in transparency for ease of illustration;

FIG. 16C is a front elevation view of the jack system of FIG. 16A shown with a cover and a brace depicted in transparency for ease of illustration;

FIG. 17A is an isometric view of a front unibody end plate of a unibody structure of the removable trimming module of FIG. 3A;

FIG. 17B is an isometric view of a rear unibody end plate of a unibody structure of the removable trimming module of FIG. 3A;

FIG. 17C is an isometric view of a unibody reel cover of a unibody structure of the removable trimming module of FIG. 3A;

FIG. 17D is an isometric view of a unibody bottom cross brace of a unibody structure of the removable trimming module of FIG. 3A;

FIG. 17E is an isometric view of a unibody middle cross brace of a unibody structure of the removable trimming module of FIG. 3A;

FIG. 17F is an isometric view of a unibody top cross brace of a unibody structure of the removable trimming module of FIG. 3A;

FIG. 17G is an isometric view of a tumbler retaining rod of a unibody structure of the removable trimming module of FIG. 3A;

FIG. 18 is a front-top-right view of a unibody structure including the unibody components of FIGS. 17A-17G installed in an extrusion frame of the removable trimming module of FIG. 3A;

FIG. 19 is an isometric view of a helical-bladed cutting reel assembly of the removable trimming module of FIG. 3A;

FIG. 20 is an isometric view of a tumbler assembly of the removable trimming module of FIG. 3A;

FIG. 21 is a left rear view of a tumbler adjustment mechanism of the removable trimming module of FIG. 3A;

FIG. 22A is an isometric view of a cutting knife assembly of the removable trimming module of FIG. 3A;

FIGS. 22B-22G are top, left, front, right, rear and bottom views of the cutting knife assembly of FIG. 22A;

FIG. 23 is an isometric view of a helical pan assembly of the removable trimming module of FIG. 3A;

FIG. 24 is an isometric view of a brush assembly of the removable trimming module of FIG. 3A;

FIG. 25 is a left bottom perspective view of the removable power pack module of FIG. 5, shown with upper and lower extrusion covers removed; and

FIG. 26 is an isometric view of a cover of the removable trimming module of FIG. 3A.

### DETAILED DESCRIPTION

### Overview

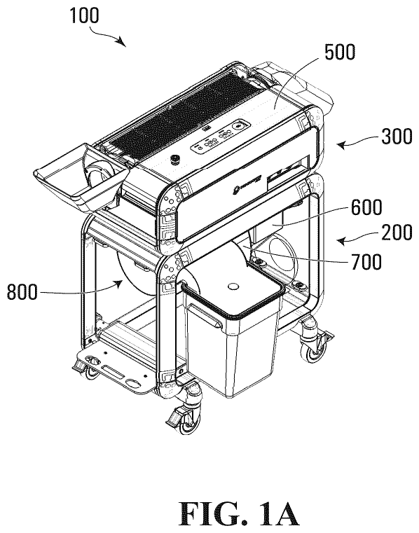

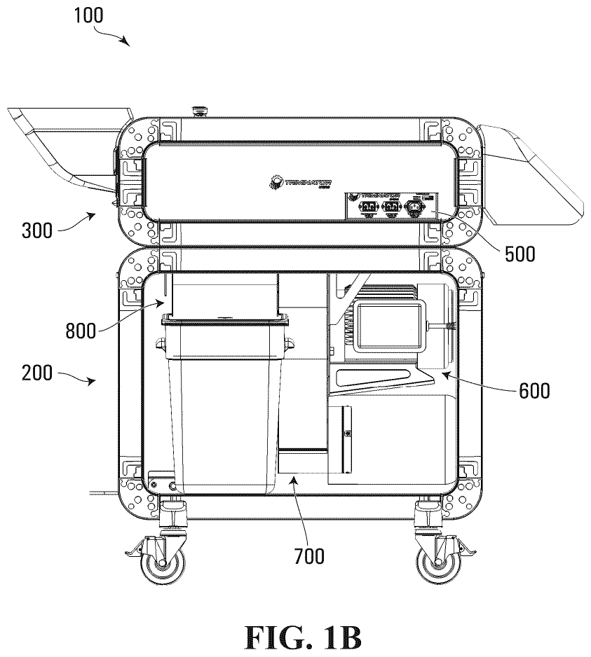

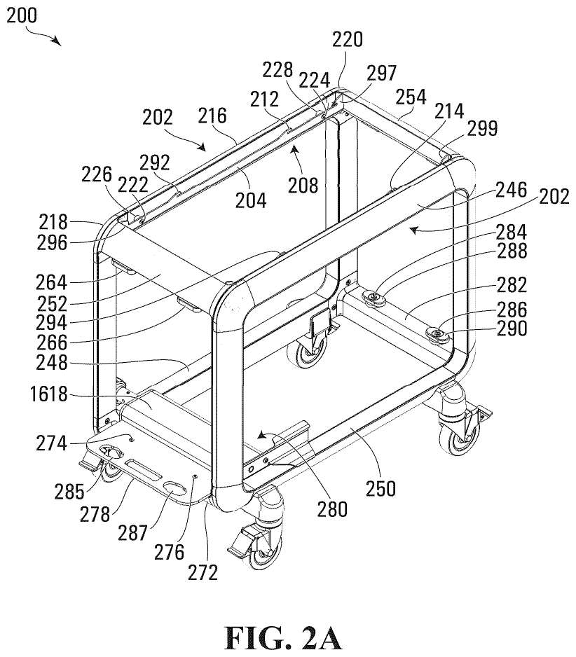

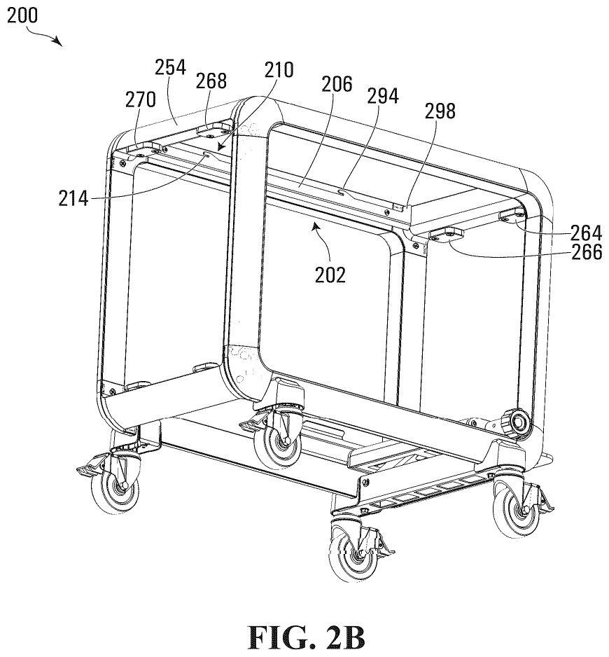

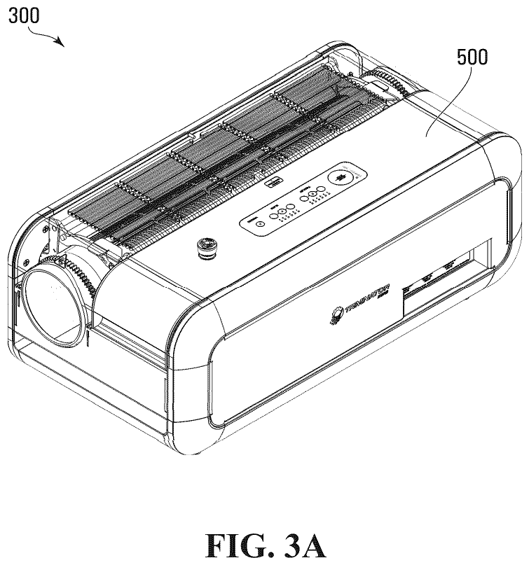

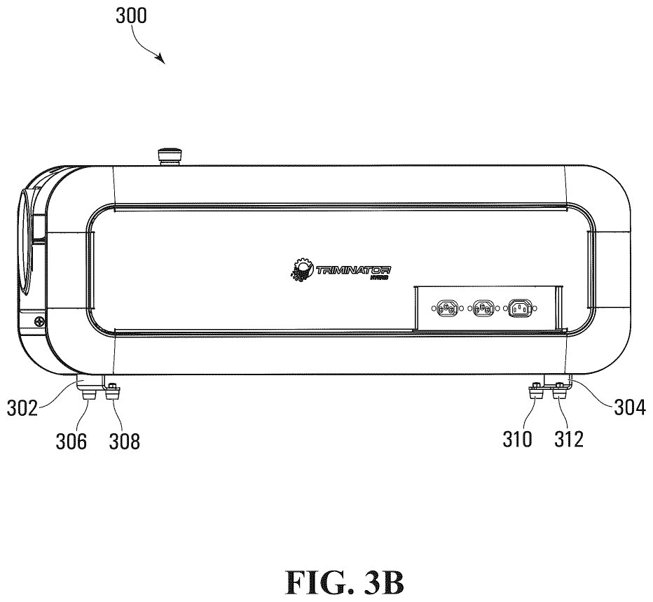

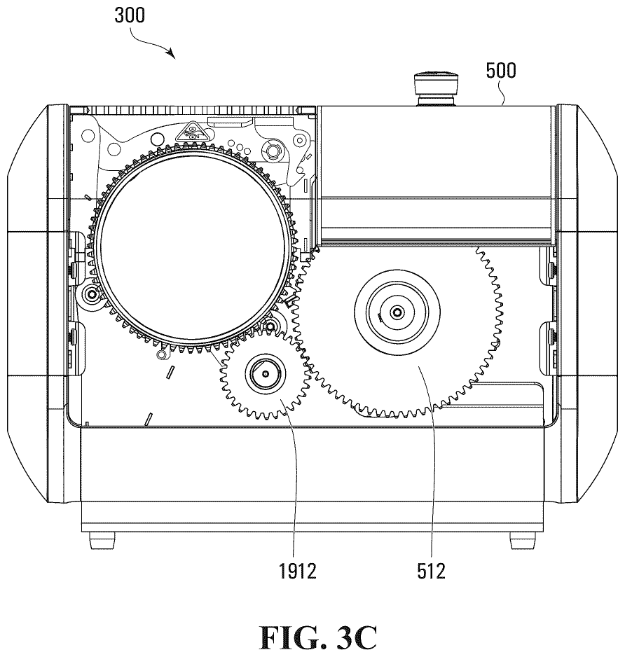

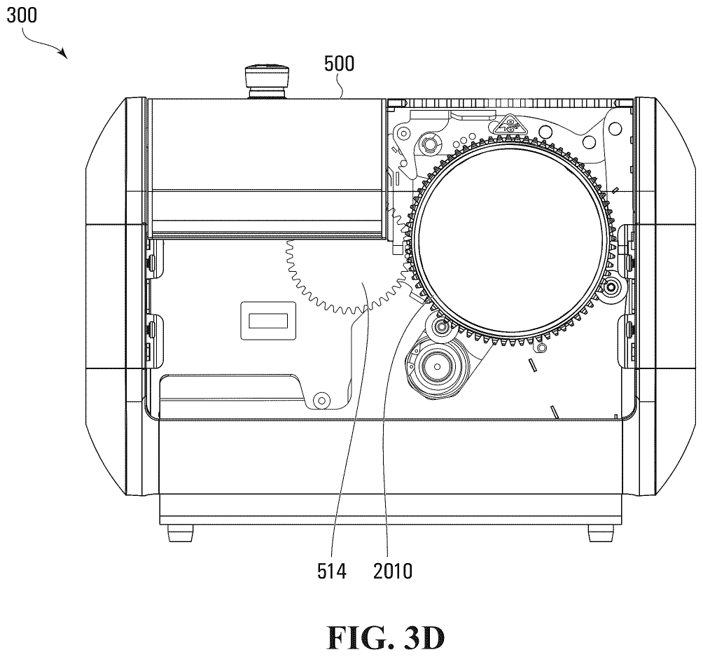

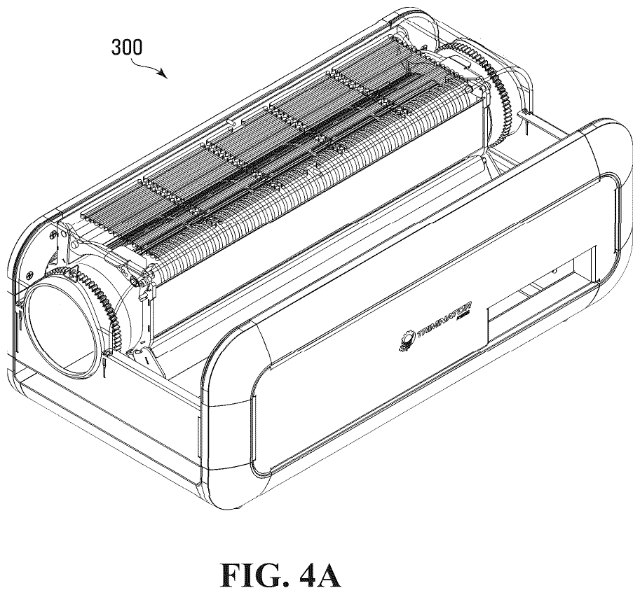

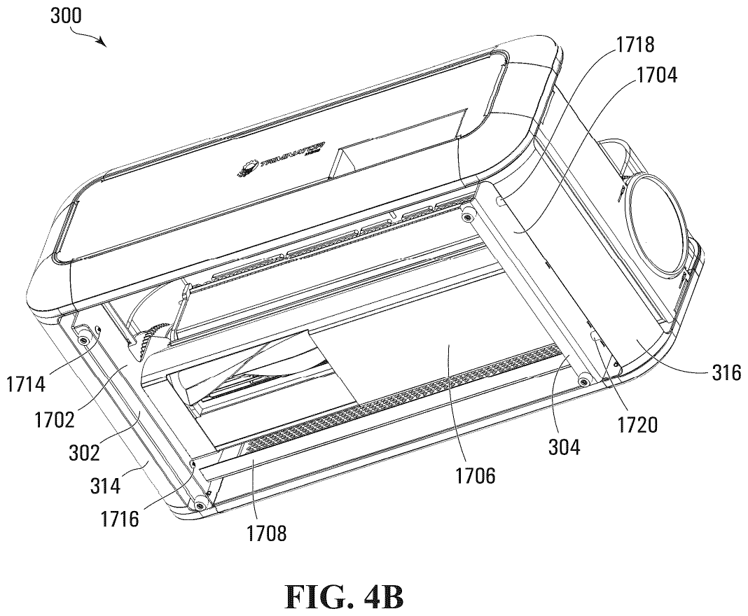

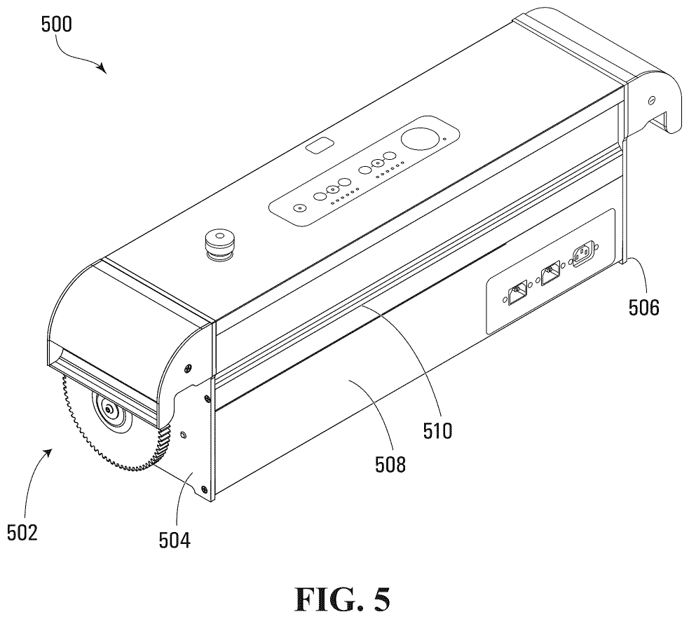

Referring to FIGS. 1A through 8, a modular plant trimming machine according to a first embodiment of the present disclosure is shown generally at 100 in FIGS. 1A and 1B. In this embodiment, the modular plant trimming machine 100 includes a removable trimming module 300 shown in FIGS. 3-4 which, as discussed in greater detail below, includes a tumbler, a cutting reel and a knife. In this embodiment, the modular plant trimming machine 100 also includes a removable power pack module 500 shown in FIG. 5, configured to rotate the tumbler and the cutting reel of the removable trimming module 300. In this embodiment the modular plant trimming machine 100 further includes a chassis 200 shown in FIGS. 2A and 2B, configured to removably receive and support the removable trimming module 300 in mechanical communication with the removal power pack module 500.

More particularly, in this embodiment the removable trimming module 300 is configured to removably receive and support the removable power pack module 500. FIG. 3 shows the removable power pack module 500 received and supported by the removable trimming module 300, while FIG. 4 shows the removable trimming module 300 when the removable power pack module 500 has been removed.

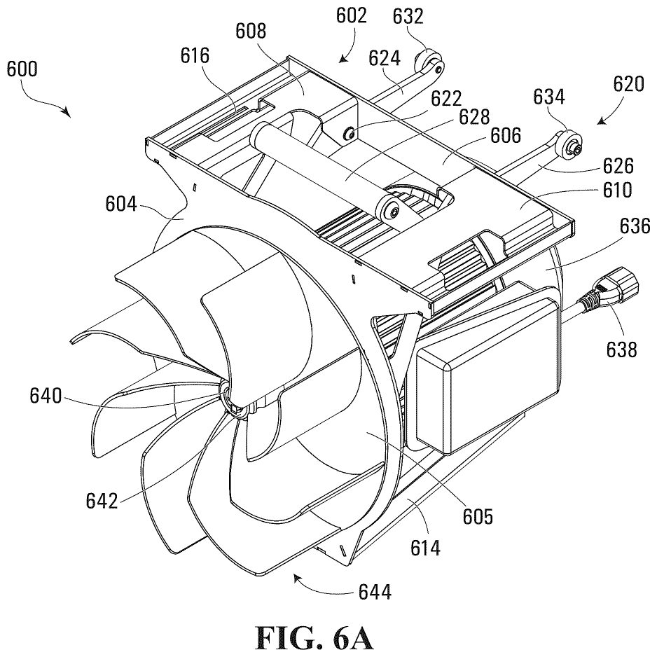

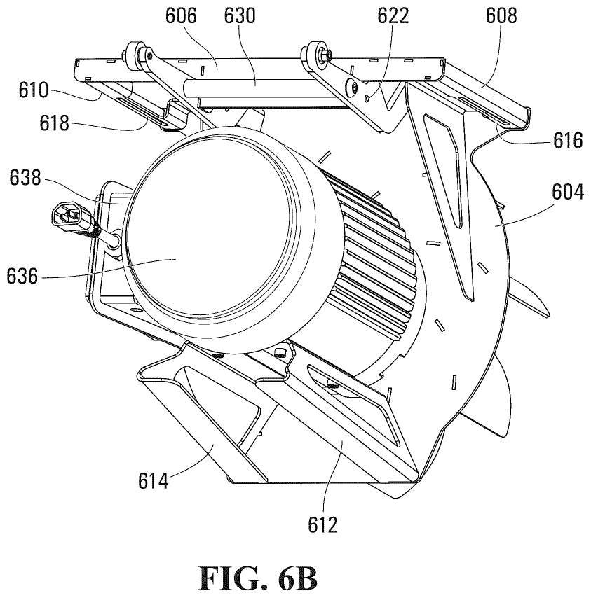

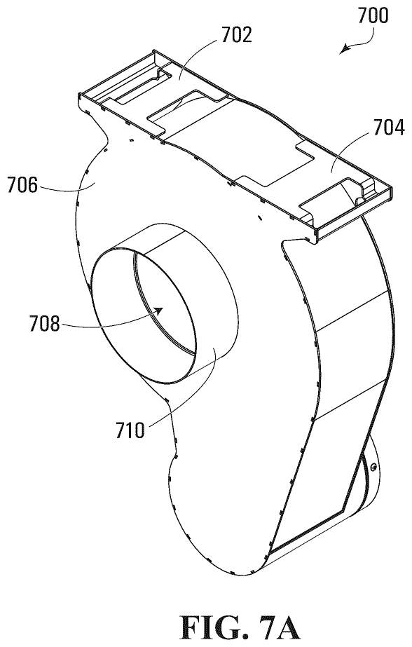

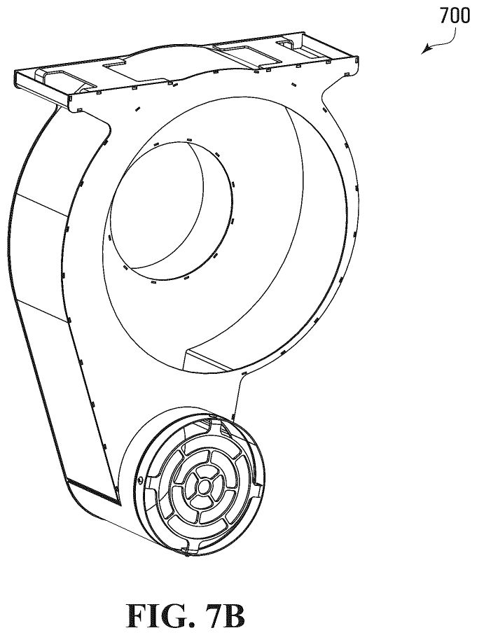

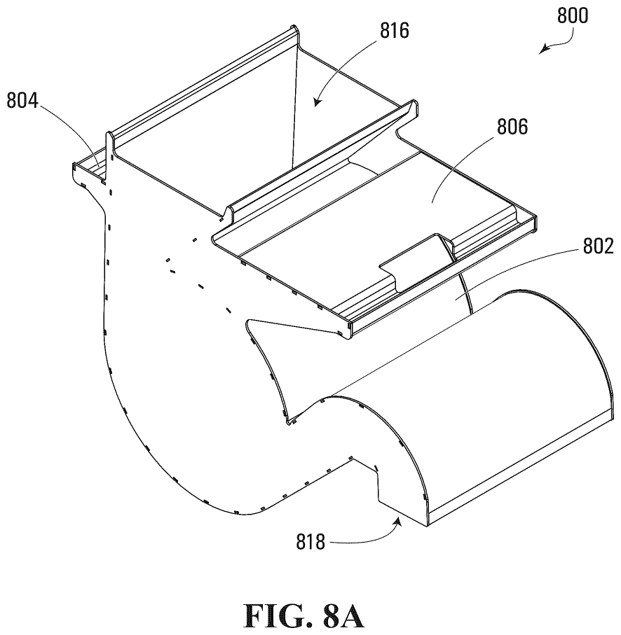

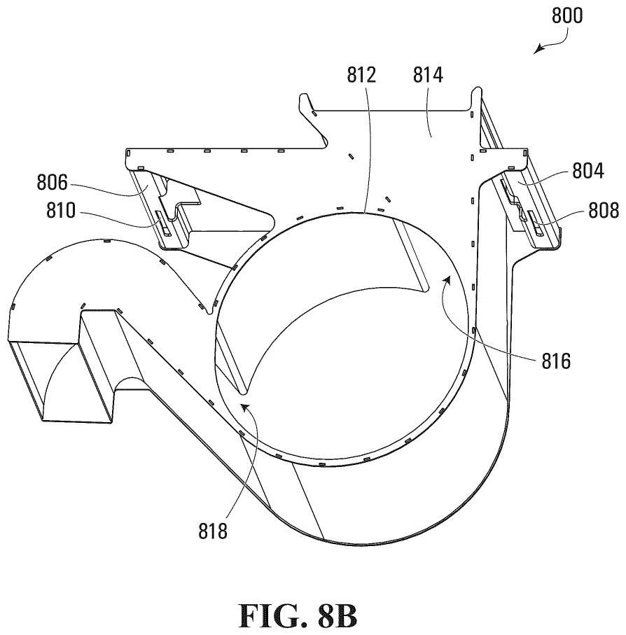

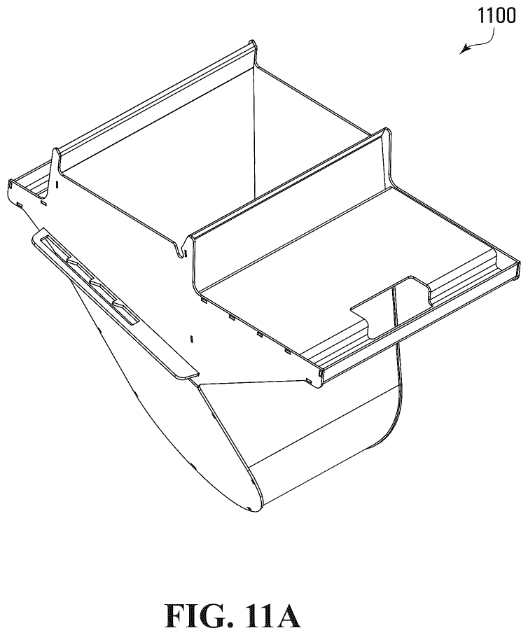

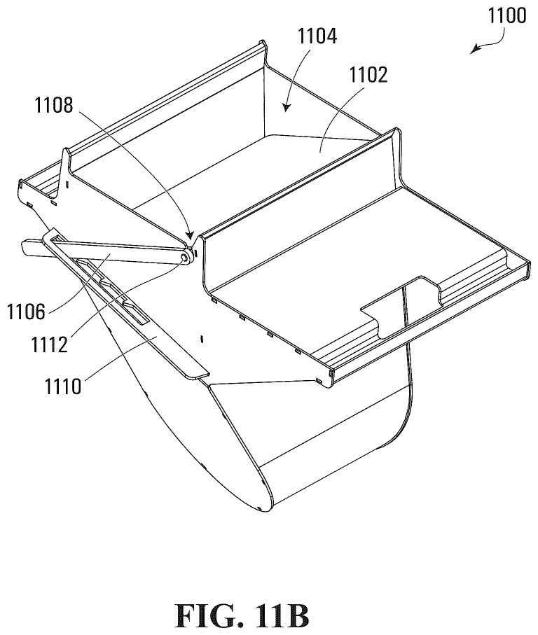

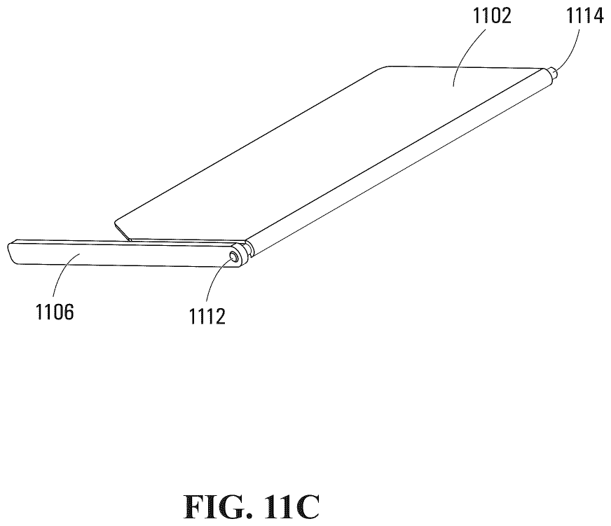

Referring to FIGS. 1B, 2 and 6A-8, in this embodiment the chassis 200 is further configured to removably receive and support a removable fan motor module 600 shown in FIGS. 6A-6B, a removable fan blade housing module 700 shown in FIGS. 7A-7B, and a removable airflow module, which in this embodiment is an interchangeable module. In this embodiment, the interchangeable module includes a centrifugal gas separator module 800 shown in FIG. 8. Alternatively, in other embodiments the interchangeable module may include a plenum module 1100 shown in FIG. 11, for example.

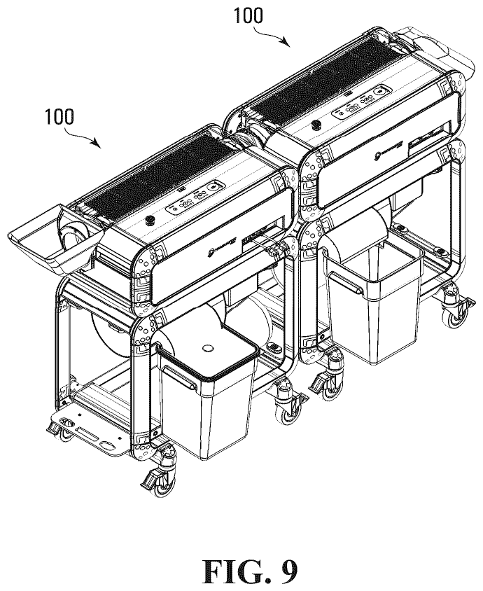

Depending on the specific parameters of the desired application, the modular plant trimming machine may be operated in isolation, or alternatively may be connected in tandem (in series) with other identical or non-identical plant trimming machines. For example, FIG. 9 shows two of the modular plant trimming machine 100 of FIG. 1A connected in tandem (in series), with the output of the upstream tumbler connected to the input of the downstream tumbler.

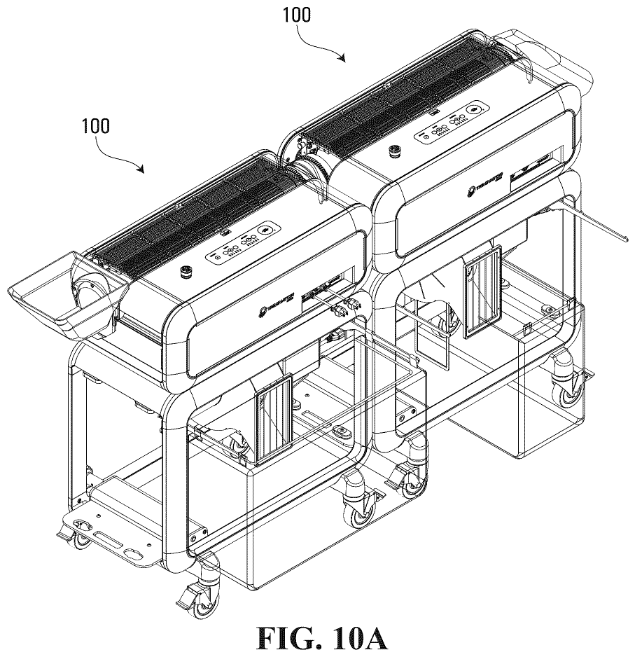

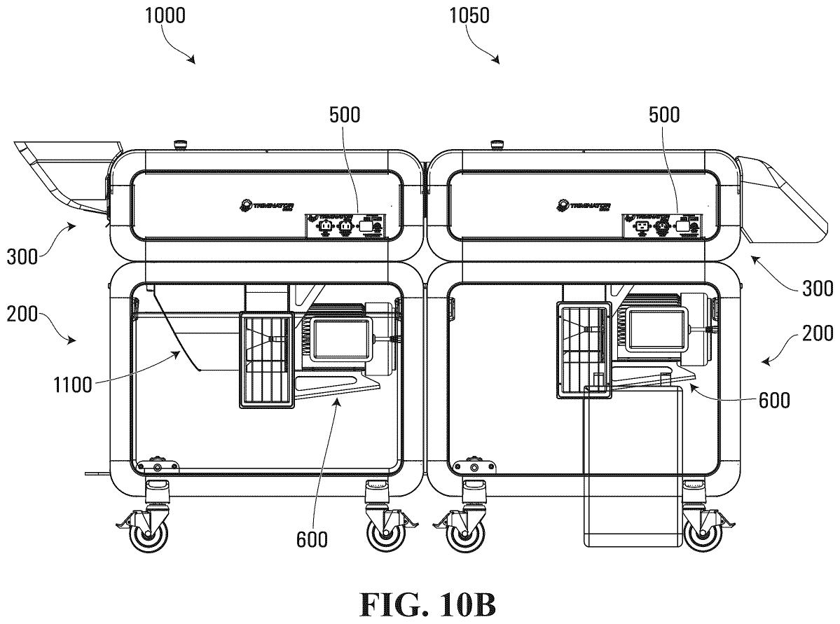

As a further example, FIGS. 10A and 10B show two non-identical plant trimming machines, namely a modular plant trimming machine 1000 and a modular plant trimming machine 1050, connected in tandem (in series). Compared to the modular plant trimming machine of FIG. 1A, the modular plant trimming machine 1000 replaces the separator module 800 with a plenum module 1100, and in such embodiments the chassis is further configured to removably receive and support the removable plenum module 1100. The modular plant trimming machine 1050 omits the separator module 800 of the machine 100. A novel tandem connection system is among the numerous innovative aspects of illustrative embodiments described in greater detail below.

### Main Chassis and Module Support System

Referring to FIGS. 2A-2B, 6-7 and 12A-12B, in this embodiment the chassis 200 of the modular plant trimming machine 100 includes a support system shown generally at 202, configured to support a removable induction assembly module as discussed below. The support system 202 includes a first rail 204 and a second rail 206. In this embodiment the first and second rails 204 and 206 are spaced apart at opposite ends of the chassis 200, and are configured to support first and second opposite ends of the removable induction assembly module resting thereon. In this embodiment, the first and second rails 204 and 206 are parallel, although in other embodiments non-parallel rails may be substituted, provided their configuration is capable of performing the support functions of the rails as described herein.

In this embodiment, the chassis 200 further includes at least one induction assembly module retention mechanism configured to operably secure the removable induction assembly module in the chassis. More particularly, in this embodiment the at least one induction assembly module retention mechanism includes first and second induction assembly module retention mechanisms shown generally at 208 and 210, engageable with first and second opposite ends of the removable induction assembly module. In this embodiment, the first rail 204 includes the first retention mechanism 208, and the second rail 206 includes the second retention mechanism 210.

More particularly still, in this embodiment the first and second induction assembly module retention mechanisms 208 and 210 include first and second hooks 212 and 214 protruding from the first and second rails 204 and 206 respectively, the first and second hooks 212 and 214 being respectively engageable with first and second slots 616 and 618 defined in the first and second opposite ends of the removable induction assembly module.

In this regard, in this embodiment the removable induction assembly module includes two removable induction modules, namely, the removable fan motor module 600 shown in FIGS. 6A-6B, and the removable fan blade housing module 700 shown in FIGS. 7A-7B. Alternatively, in other embodiments these two modules may be combined in a single module, or other removable induction assembly modules may be substituted.

The removable fan motor module 600 of the present embodiment includes a housing 602. First and second slots 616 and 618 are defined through the housing at first and respective opposite ends thereof, and the first and second hooks 212 and 214 of the rails 204 and 206 of the chassis 200 are engageable with the first and second slots 616 and 618, respectively, to secure the removable fan motor module 600 in the chassis 200, as discussed in greater detail below.

In this embodiment, the first and second rails 204 and 206 are further configured to support the removable fan blade housing module 700 shown in FIGS. 7A-7B. Unlike the removable fan motor module 600, in this embodiment the chassis 200 has no hooks or other specific retention mechanism dedicated to the removable fan blade housing module 700. Instead, as discussed below, the chassis 200 cooperates with the removable fan motor module 600 to retain the removable fan blade housing module 700 in the chassis.

Additionally, in this embodiment the support system 202 is further configured to support at least one removable airflow module upstream of the removable induction assembly module. More particularly, in this embodiment the at least one removable airflow module includes the removable centrifugal gas separator module 800, and the first and second rails 204 and 206 are spaced apart and configured to support first and second opposite ends of the removable centrifugal gas separator module 800 resting thereon. Alternatively, in some embodiments the support system 202 may be spaced apart and configured to support first and second opposite ends of the removable plenum module 1100 resting thereon, or may be configured to support other devices or modules instead of the removable centrifugal gas separator module 800. In other embodiments the support system 202 may omit structural support for additional devices or modules.

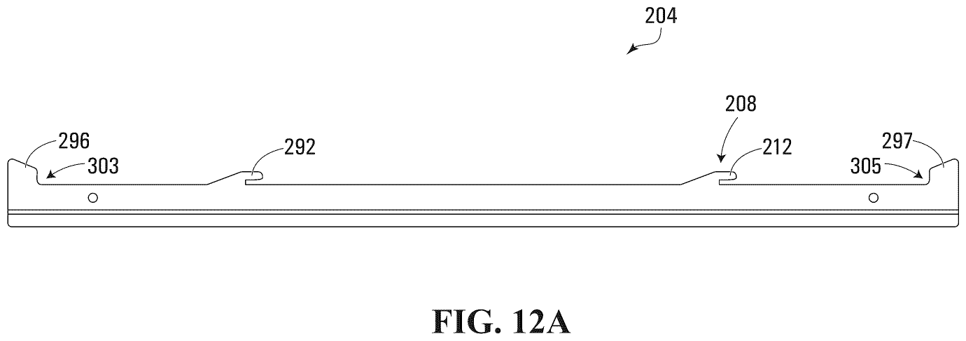

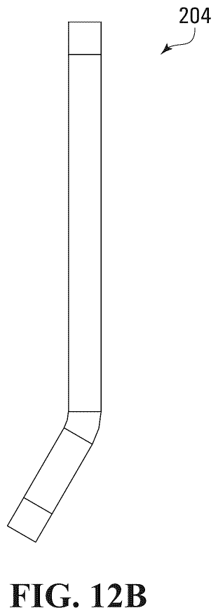

Referring to FIGS. 12A and 12B, the first rail 204 is shown in greater detail. In this embodiment, the second rail 206 is a mirror image of the first rail 204, and therefore, a detailed description of the second rail 206 is omitted to avoid redundancy.

In this embodiment, the first rail 204 is composed of a stainless alloy (preferably 304 or 316), connected to a frame of the chassis 200, which in this embodiment is an extrusion frame. More particularly, in this embodiment the first rail 204 is connected to a first upper crossbar 216, a first corner joint 218 and a second corner joint 220 of the chassis 200, by first and second connectors 222 and 224, which in this embodiment include first and second button head cap screws (BHCS). The first connector 222 extends through the first rail 204, through a first spacer 226, through a first hole defined through an inner surface of the first upper crossbar 216, and into a threaded receptacle 236 defined in the first corner joint 218. Similarly, the second connector 224 extends through the first rail 204, through a second spacer 228, through a second hole defined through the inner surface of the first upper crossbar 216, and into a threaded receptacle defined in the second corner joint 220. In this embodiment the first and second spacers 226 and 228 include unthreaded standoffs.

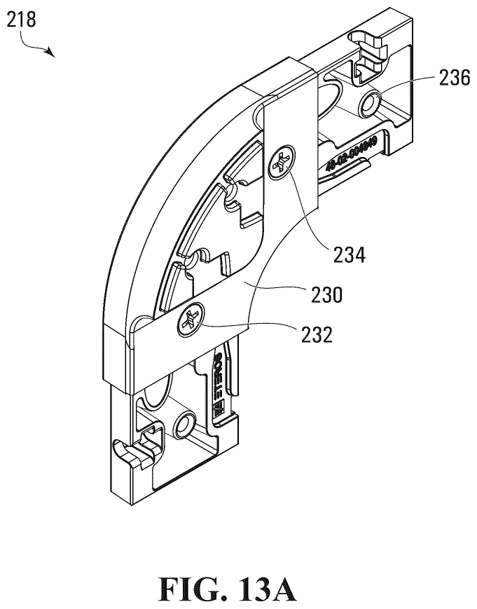

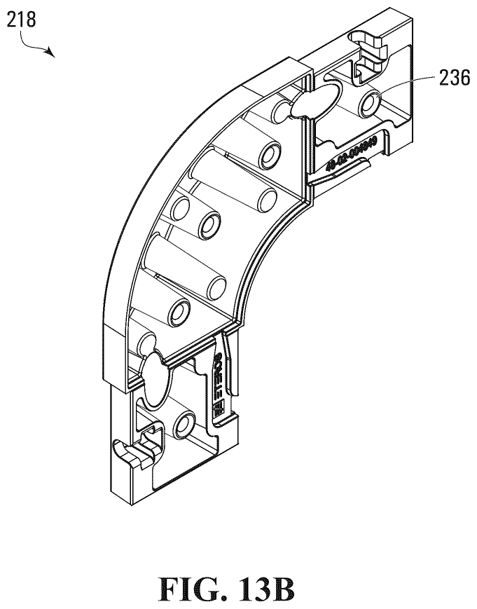

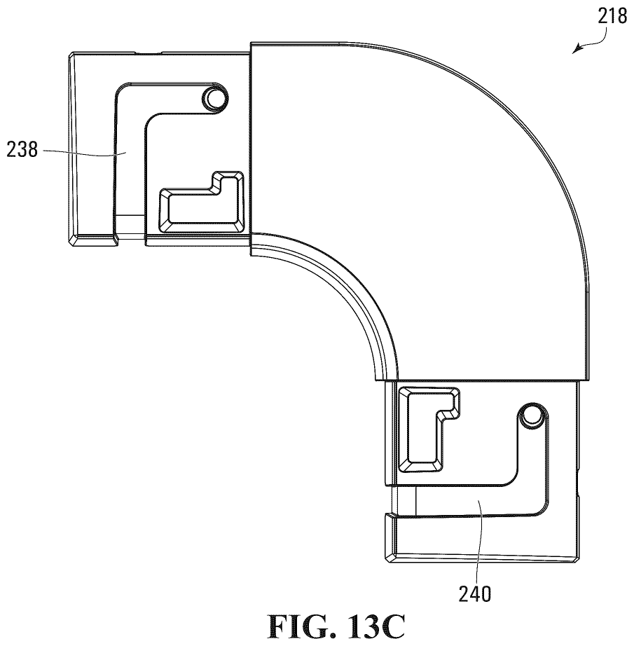

Referring to FIGS. 13A-13C, the first corner joint is shown at 218. In this embodiment, each of the other corner joints of the chassis 200 is either identical to or a mirror image of the first corner joint 218, in accordance with the symmetry of the chassis 200. In FIG. 13A, the first corner joint 218 is shown with an adapter plate 230 attached thereto by two screws 232 and 234, while in FIG. 13B the first corner joint 218 is shown with the adapter removed. Advantageously, as shown in FIG. 13C, in this embodiment the first corner joint 218 includes adhesive channels 238 and 240, to permit adhesive to be used to structurally secure the first corner joint 218 to a vertical and a horizontal crossbar of the chassis 200 without the need for bolts or other additional connectors.

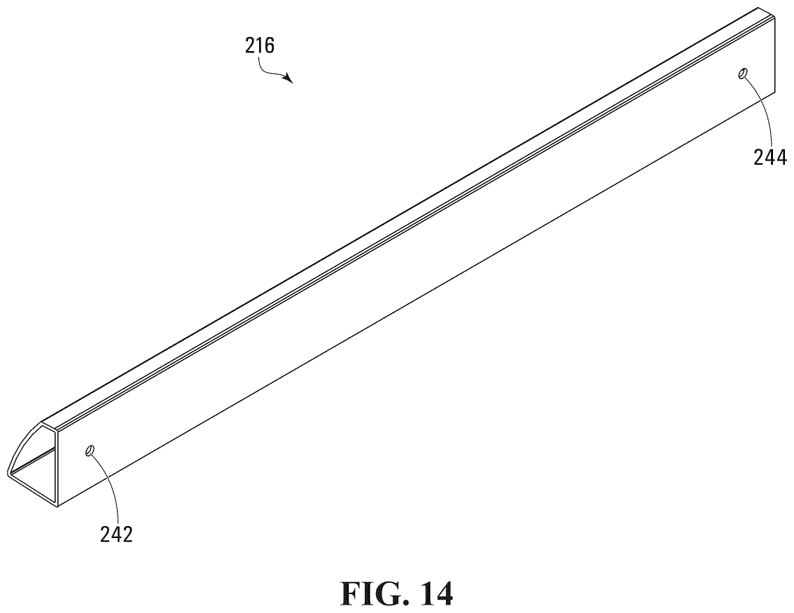

Referring to FIGS. 2A and 14, in this embodiment the first upper crossbar 216 of the extrusion frame of the chassis 200 is hollow, open-ended and has a constant, near trapezoidal cross-section along its entire length. First and second holes 242 and 244 are defined through a surface of the first upper crossbar proximate to the first rail 204, to accommodate the first and second connectors 222 and 224 which pass therethrough.

In this embodiment, a second upper crossbar 246 is a mirror image of the first upper crossbar 216. First and second lower crossbars 248 and 250 omit the holes 242 and 244 (because no rails are mounted on the lower crossbars in this embodiment) but are otherwise mirror images of the first and second upper crossbars 216 and 246.

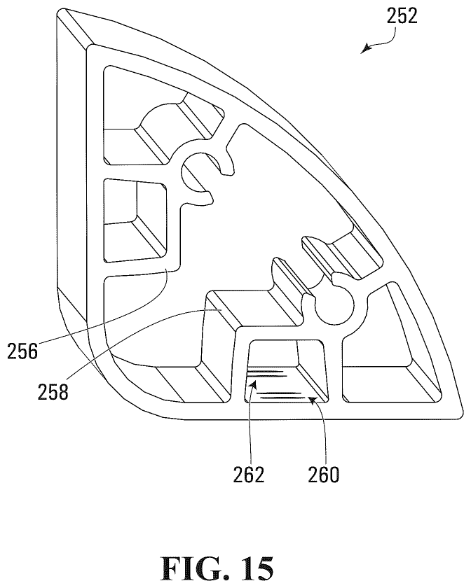

Referring to FIGS. 2A and 15, in this embodiment a third upper crossbar 252 and a fourth upper crossbar 254 are perpendicular to the first and second upper crossbars 216 and 246. The third upper crossbar 252 shown in FIG. 15 is mostly hollow by volume, but includes internal buttresses 256 and 258 extending longitudinally through the internal volume of the third upper crossbar 252 along its entire length, the buttresses defining multiple discrete longitudinal channels through the internal volume of the third upper crossbar 252. The buttresses 256 and 258 are shaped and configured so that a left end of the third upper crossbar 252 cooperates and interlocks with the adapter 230 of the left front corner joint 218, and a right end of the third upper crossbar 252 cooperates and interlocks with a mirror image adapter of the right front corner joint, to secure the third upper crossbar 252 between the left and right front top corners of the chassis 200. In this embodiment, a lower surface of the third upper crossbar 252 also includes a first pair 260 of holes and a second pair 262 of holes defined therethrough, so that first and second tandem connection bumpers 264 and 266 may each be mounted to the lower surface using a pair of screws or bolts (not shown). In this regard, in this embodiment the trimming machine 100 includes at least one spacer, or more particularly the bumpers 264 and 266, mounted on the frame and configured to be sandwiched between the frame of the trimming machine and a frame of the adjacent trimming machine. In this embodiment each of the spacers (bumpers 264 and 266) is resiliently deformable.

In this embodiment, the fourth upper crossbar 254 is a mirror image of the third upper crossbar 252, and has tandem connection bumpers 268 and 270 mounted to its lower surface.

In this embodiment, a third lower crossbar 272 is almost a mirror image of the third upper crossbar 252, except that each of the pairs 260 and 262 of holes defined through the lower surface of the third upper crossbar 252 is replaced with an individual hole defined through the upper surface of the third lower crossbar 272. The individual holes are positioned and sized for receiving mounting screws 274 and 276 therethrough, to rigidly secure a jack plate 278 (also referred to as a tandem connection plate) of a jack system 280 (discussed in greater detail below) to the upper surface of the third lower crossbar 272.

In this embodiment, a fourth lower crossbar 282 is a mirror image of the third lower crossbar 272. The fourth lower crossbar 282 has two holes defined through its upper surface, identical to those defined through the upper surface of the third lower crossbar 272, but rather than a jack plate, the two holes are shaped and configured to receive first and second mounting screws 284 and 286 therethrough, to secure first and second tandem connection keys 288 and 290 to the fourth lower crossbar 282. In this embodiment, the tandem connection keys 288 and 290 include first and second knobs, which in this embodiment are non-cylindrical and are configured to engage through first and second keyholes 285 and 287. The tandem connection knob 288 is connected to the fourth lower crossbar by the first mounting screw 284 and a metal washer, which secure the knob and another intervening washer against the upper surface of the fourth lower crossbar 282. Inside the fourth lower crossbar 282, the first mounting screw 284 is received in a nut (not shown), which in this embodiment is rotationally secured in one of the longitudinal channels defined by the internal buttresses of the crossbar. More particularly, in this embodiment the nut is rectangular or parallelogram-shape, so as to fit snugly within one of the longitudinal channels defined by the buttresses extending through the fourth lower crossbar 282 without permitting rotation of the nut. A spring (not shown) surrounds the mounting screw 284 to loosely hold the connection key 288 in position against the fourth lower crossbar 282, while permitting rotation of the knob 288 relative to the fourth lower crossbar 282. The second tandem connection knob 290 is similarly mounted.

### Jack System

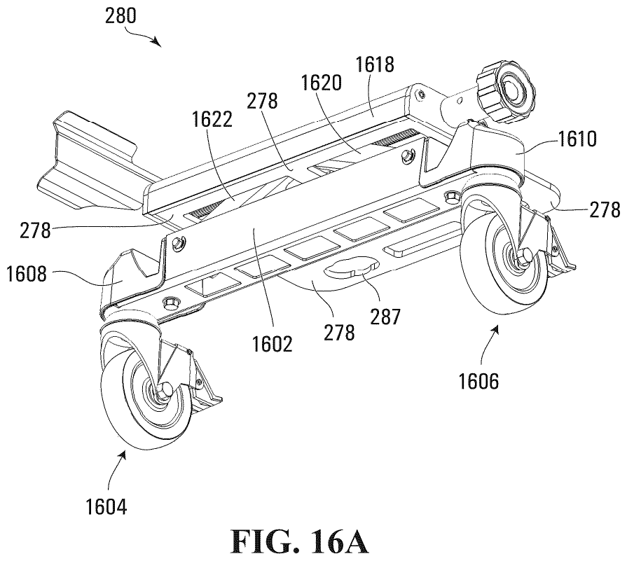

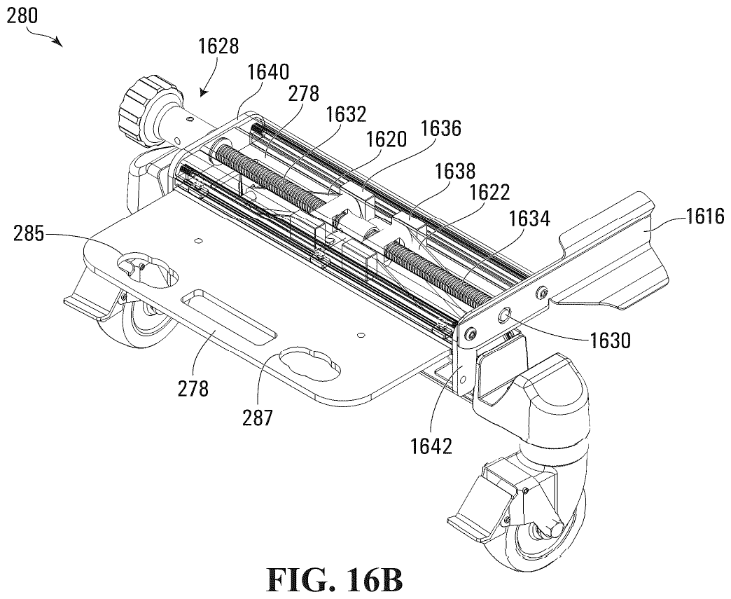

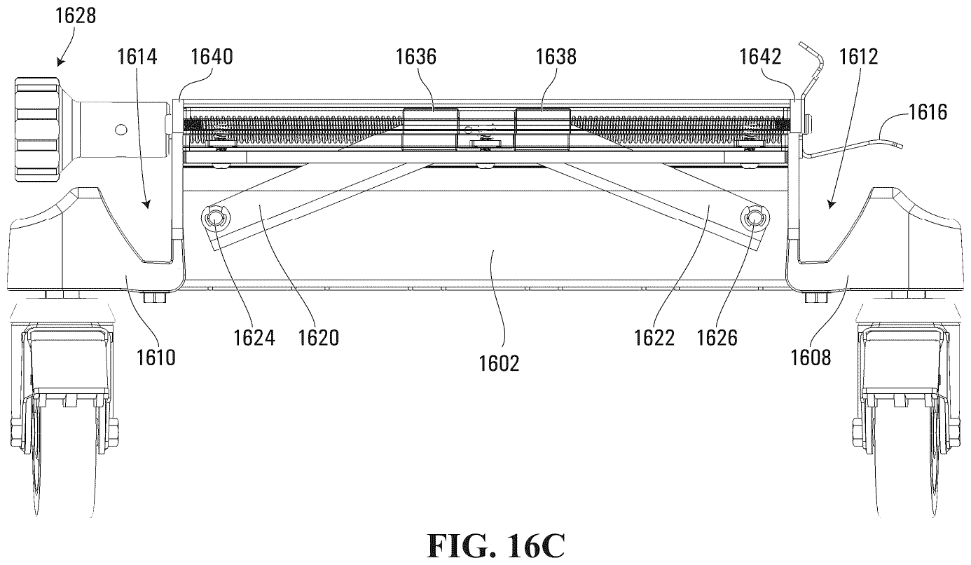

Referring to FIGS. 2A-2B and 16A-16C, the jack system is shown generally at 280 in FIG. 16A. In this embodiment, the jack system 280 includes an elongated jack base 1602, to which first and second wheels 1604 and 1606 are mounted at opposite ends thereof, via respective mounting brackets 1608 and 1610 that are secured to the opposite ends of the jack base 1602. In this embodiment, the jack base 1602 maintains a fixed vertical height above the ground, corresponding to the height of the wheels 1604 and 1606, and the jack system, 280 operates by raising and lowering the jack plate 278 relative to the jack base 1602, with the jack plate 278 (rather than the jack base 1602) being maintained in rigid relationship with the frame of the chassis 200.

Consequently, in this embodiment the extruded frame of the chassis 200 is not generally supported by the jack base 1602 from beneath, except when the jack plate 278 is at its lowest possible height above the jack base 1602, in which case the front ends of the first and second lower crossbars 248 and 250 shown in FIG. 2A, rest in respective guide slots 1614 and 1612 shown in FIG. 16C defined in the mounting brackets 1610 and 1608, respectively.

Instead, in this embodiment the jack system 280 is secured to the frame of the chassis from above. The jack plate 278 is bolted to the upper surface of the third lower crossbar 272 via the mounting screws 274 and 276. Each of the mounting screws 274 and 276 extends through its corresponding hole defined through the jack plate 278, and through a corresponding hole defined through the upper surface of the third lower crossbar 272, where it is received in a corresponding nut (not shown) secured within one of the longitudinal channels defined by the internal buttresses extending through the inner volume of the third lower crossbar 272. The nut is preferably rectangular, or a parallelogram, or is otherwise shaped and sized to be snugly secured in the longitudinal channel to lock the nut against rotation within the third lower crossbar 272. A spring (not shown) surrounding each mounting screw biases the upper surface of the third lower crossbar 272 against a lower surface of the jack plate 278.

In this embodiment, a tote support bracket 1616 is also mounted to one side of the jack system 280.

Referring to FIGS. 2A-2B and 16A-16C, the jack system 280 is shown in FIGS. 16B-16C with a top cover 1618 and the jack base 1602 depicted in transparency for ease of illustration, though in reality these components are typically opaque. In this embodiment, the jack system 280 includes first and second scissor arms 1620 and 1622, pivotally connected to the jack base 1602 at fixed pivot points 1624 and 1626 respectively. More particularly, each scissor arm is connected at each of the fixed pivot points by a clevis pin extending through the scissor arm and through holes defined through both sides of the jack base 1602, with the opposite ends of each clevis pin secured by two e-rings, outside the front and the back side of the jack base 1602.

In this embodiment, the jack system 280 includes a vertically movable section, including the jack plate 278. In this embodiment, the vertically movable section further includes the cover 1618, which is bolted to the jack plate 278 with three vertical screws extending upward through holes defined in the jack plate 278 and into threaded receptacles defined in the lower surface of a front edge of the cover 1618. In this embodiment, the vertically movable section further includes left and right side plates 1640 and 1642, which in this embodiment are bolted to the cover 1618. Also in this embodiment, the jack plate 278 has apertures defined therethrough, of sufficient size and shape to accommodate the scissor arms 1620 and 1622 extending therethrough.

In this embodiment, the vertically movable portion further includes a jack shaft 1630. One end of the jack shaft 1630 is received in a flange sleeve bearing mounted in the right side plate 1642, to allow the jack shaft 1630 to rotate freely about its central axis. An opposite end of the jack shaft 1630 extends through the left side plate 1640 and is connected to an actuator 1628, which in this embodiment is a rotatable knob. Manual rotation of the actuator 1628 by a user causes the jack shaft 1630 to rotate in unison with the actuator.

In this embodiment, the jack shaft 1630 has a first portion 1632 having a first threaded orientation, and a second portion 1634 having a second threaded orientation opposite to the first threaded orientation. More particularly, in this embodiment the first portion 1632 is right-hand threaded, and the second portion 1634 is left-hand threaded. In this embodiment, as the actuator 1628 is rotated clockwise, a helix matrix formed by the threads of the first portion 1632 effectively moves inward toward the centre of the jack system 280, thereby forcing a thread block 1636 of the first scissor arm 1620 outward to the left, toward the actuator 1628 at the left side of the chassis 200, while at the same time a helix matrix formed by the threads of the second portion 1634 effectively moves in the opposite direction, thereby forcing a thread block 1638 of the second scissor arm 1622 outward to the right, toward the tote guide 1616 at the right side of the chassis 200. Thus, clockwise rotation of the actuator 1628 causes the thread blocks 1636 and 1638 to move outward toward the left and right sides of the jack. Since the lower ends of the scissor arms 1620 and 1622 are fixed at the pivot points 1624 and 1626, the outward motion of the thread blocks 1636 and 1638 causes the scissor arms 1620 and 1622 to pivot about the pivot points 1624 and 1626, thereby vertically raising the thread blocks 1636 and 1638 relative to the height of the pivot points 1624 and 1626, which vertically raises the jack shaft 1630, which vertically raises the side plates 1640 and 1642, which vertically raises the cover 1618 to which the side plates 1640 and 1642 are connected, which in turn vertically raises the jack plate 278 to which the cover 1618 is connected. In other words, turning the actuator 1628 clockwise vertically raises the height of the jack plate 278 to extend further above the jack base 1602, while turning the actuator 1628 counter clockwise vertically lowers the height of the jack plate 278 by bringing it closer to the jack base 1602. Also in this embodiment, since the jack plate 278 is rigidly connected to the third lower crossbar 272 of the frame of the chassis 200, turning the actuator 1628 clockwise or counter clockwise vertically raises or lowers the height of the frame of the chassis 200 above the jack base 1602 on the front (input) side of the trimming machine 100, while leaving the height of the frame of the chassis 200 on the rear (output) side unaffected. This adjustability may be useful to control the tilt of the machine and hence the speed and dwell time of the plant material within the tumbler, or to align the trimming machine for connection to another trimming machine in tandem (in series), with the output of one trimming machine connected to the input of the another trimming machine.

### Removable Induction Assembly Module

Referring back to FIGS. 6A, 6B and 7, in this embodiment the machine 100 includes two removable induction assembly modules, namely, the removable fan motor module 600 and the removable fan blade housing module 700.

### Fan Motor Module

In this embodiment, the removable fan motor module 600 includes a housing shown generally at 602, which includes a front plate 604, an impeller plate 605, a rear plate 606, a top left plate 608, a top right plate 610, and left and right motor legs 612 and 614. In this embodiment, an outermost portion of the top left plate 608 is configured to be supported by the first rail 204 of the chassis 200, and an outermost portion of the top right plate 610 is configured to be supported by the second rail 206 of the chassis 200. Also in this embodiment, a first slot 616 is defined through the top left plate 608, and similarly, a second slot 618 is defined through the top right plate 610. The first and second slots 616 and 618 are shaped and configured to engage with respective hooks 212 and 214 of the first and second rails 204 and 206 of the chassis 200.

In this embodiment, the removable induction assembly module, or more particularly the fan motor module 600, includes an actuator 620 configured to operably secure the removable induction assembly module in the chassis 200. More particularly, in this embodiment the actuator 620 is configured to securely engage the hooks 212 and 214 in the slots 616 and 618 to operably secure the removable induction assembly module in the chassis 200. In this embodiment the actuator 620 includes a lever pivotally mounted to the removable induction assembly module. More particularly, in this embodiment the lever includes a left lever arm 624 and a right lever arm 626, which in this embodiment lie in generally parallel spaced apart vertical planes. In this embodiment, the left lever arm 624 and the right lever arm 626 are connected at their front ends by a handle 628, and are connected rearward of the rear plate 606 by a reinforcement bar 630.

In this embodiment, the actuator 620 includes a spacer resiliently engageable between the chassis 200 and the removable induction assembly module to apply a force therebetween, to maintain the hooks 212 and 214 secured in the slots 616 and 618. In this embodiment the spacer includes a roller. More particularly, in this embodiment the spacer includes first and second roller bearings 632 and 634, which in this embodiment include resiliently deformable urethane, mounted the rear ends of the left and right lever arms 624 and 626 about a left-to-right axis.

When installing the fan motor module 600 in the chassis 200, the fan motor module 600 is lowered into the chassis 200 so that lower surfaces of the left and right top plates 608 and 610 of the fan motor module 600 rest on the rails 204 and 206 of the chassis, with the hooks 212 and 214 of the rails 204 and 206 protruding upward through the slots 616 and 618 that are defined through the left and right top plates 608 and 610. A user may then press downward on the handle 628, thereby causing the first and second roller bearings 632 and 634 to move on a slight upward and outward arc as they increasingly bear against a front surface of the fourth upper crossbar 254, thereby increasingly forcing the fan motor module 600 to move forward in the chassis 200, until the handle 628 is fully depressed downward, at which point the hooks 212 and 214 are rigidly bearing against the rear ends of the slots 616 and 618, indicating that the fan motor module is firmly locked in its intended position. To remove the fan motor module 600 from the chassis 200, the user lifts the handle 628 of the lever, thereby moving the roller bearings 632 and 634 on a downward and forward arcuate path, until they are out of contact with the fourth upper crossbar 254 and no longer applying any force between the chassis and the fan motor module, to allow the fan motor module 600 to slide rearward to disengage the hooks 212 and 214 from the slots 616 and 618, thereby allowing the fan motor module 600 to be simply lifted up out of the chassis 200.

The fan motor module 600 includes a fan motor 636, which in this embodiment is a 1.5 hp, 120 VAC 60Hz electric motor having a power connection interface 638. In this embodiment the fan motor 636 is sealed and can be washed, either in situ or after removal. A drive shaft 640 of the fan motor 636 extends through the front plate 604 and the impeller plate 605, where it is connected via a hub 642 to a plurality of fan blades shown generally at 644.

### Removable Fan Blade Housing Module and Removable Separator Module

Referring to FIGS. 2A-2B, 7A-7B and 8A-8B, in this embodiment the removable separator module 800 includes a centrifugal gas separator 802, similar to that disclosed in the Applicant's issued U.S. Pat. No. 10,646,885, which is hereby incorporated herein by reference, but modified in a number of ways.

The separator 802 of the present embodiment includes a top left plate 804 and a top right plate 806, configured to engage with the first and second rails 204 and 206 respectively, to cause the separator module 800 to rest on the rails 204 and 206 of the chassis 200.

In this embodiment, the chassis 200 includes a separator retention mechanism to retain the separator module 800 in the chassis 200. More particularly, in this embodiment the separator retention mechanism includes a third hook 292 defined in the first rail 204, and a fourth hook 294 defined in the second rail 206, respectively. In this embodiment, the third hook 292 is configured to engage through a slot 808 defined through the left top plate 804 of the separator module 800, and similarly, the fourth hook 294 is configured to engage through a slot 810 defined through the top right plate 806.

During operation of the plant trimming machine 100, the removable fan blade housing module 700 is sandwiched between the removable fan motor module 600 and the removable separator module 800, with all three modules supported on the rails 204 and 206 of the chassis 200. Electrical power is applied to the fan motor module 600 to spin the fan's blades within the fan blade housing module 700, to thereby apply negative pressure (vacuum or suction) to an opening 812 defined in a rear wall or plate 814 of the separator module 800. The negative pressure draws ambient air rapidly downward into the separator 802 through a peripheral input port 816, causing the air to rotate within the body of the separator 802. The peripheral input port 816 is positioned adjacent the removable trimming module, and therefore the ambient air that is being drawn into the separator 802 tends to be contaminated with particulate material including leaf trimmings and dust. As the ambient air is drawn into the separator 802, outward centrifugal force from the rotation of the air within the separator tends to force the particulate matter radially outward toward an exhaust port 818, via which the particulate matter exits the separator 802 (e.g. into a collection bin), thereby separating the particulate matter from the comparatively cleaner air near the central region of the separator, which is then drawn into the fan blade housing module 700 by the rotation of the fan blades.

In this embodiment, the removable fan blade housing module 700 includes a left top plate 702 and a right top plate 704, configured to engage with the rails 204 and 206 of the chassis 200 to cause the fan blade housing module 700 to rest on the rails 204 and 206. Unlike the top plates of the fan motor module and separator module however, in this embodiment the left and right top plates 702 and 704 of the removable fan blade housing module lack any slots for engagement with corresponding hooks or other retention mechanisms of the chassis 200. Instead, in this embodiment the fan blade housing module 700 is maintained in its correct position by its surrounding modules 600 and 800 and by the chassis 200.

In this embodiment, the fan blade housing module 700 further includes a front plate 706 through which an opening 708 is defined, to allow airflow between the fan blade housing module and its next upstream module, which in this embodiment is the separator module 800. When the modules 700 and 800 are in operational position on the rails 204 and 206, the opening 708 defined through the front plate 706 of the fan blade housing module 700 aligns substantially coaxially with the opening 812 defined through the rear plate 814 of the separator module 800, although in this embodiment the opening 708 has a smaller diameter than the opening 812.

In the present embodiment, the fan blade housing module 700 further includes a cylindrical baffle 710 extending outwardly away from the front plate 706 in a direction normal to the front plate 706. When the modules 700 and 800 are operationally positioned in the chassis adjacent each other, the cylindrical baffle 710 extends through the opening 812 to protrude partly into the interior volume of the separator 802. In this regard, the ambient air entering the separator 802 may occasionally tend to short-cycle, being drawn out of the separator 802 and into the fan blade housing module before having undergone sufficient rotation within the separator to centrifugally remove all or most of the particulate material from the air. Advantageously, the present inventors have found that the cylindrical baffle 710 reduces this short-cycling tendency, thereby reducing the tendency for particulate material to spill through the opening 708 into the fan blade housing module 700.

Alternatively, if desired, the cylindrical baffle 710 may be provided as part of the removable centrifugal gas separator module 800 instead of being part of the fan blade housing module 700. For example, the opening 812 in the rear plate 814 may be narrowed in diameter to correspond to that of the opening 708, and the cylindrical baffle may extend inward (frontward) from the rear plate 814 of the separator module rather than from the front plate of the fan blade housing module.

### Removable Trimming Module

Referring to FIGS. 2A through 5, in this embodiment the chassis 200 is also configured to support the removable trimming module 300, which in this embodiment also includes the removable power pack module 500. More particularly, in this embodiment the same rails 204 and 206 that support the removable airflow and separation modules 600, 700 and 800, are also configured to support the removable trimming module 300 including the removable power pack module 500.

In this regard, referring to FIG. 3B, in the present embodiment the removable trimming module 300 has a front support leg 302 and a rear support leg 304. Also in this embodiment, the front support leg 302 has a left foot 306 and a right foot 308, each in the form of a bumper secured to the support leg 302 by a bolt inside the bumper and a nut. Similarly, in this embodiment the rear support leg 304 has a left foot 310 and a right foot 312, each including a bumper similar to those of the front support leg.

In this embodiment, each of the support legs 302 and 304 is formed by an L-shaped bottom portion of a respective front or rear unibody end plate of the trimming module 300, extending below a bottom plane of the trimming module 300 defined by the lower surfaces of an extrusion frame of the trimming module 300. In this embodiment the extrusion frame of the trimming module is similar to the extrusion frame of the chassis 200 discussed in greater detail above, and includes similar joints and crossbar structures to those shown in FIGS. 2A-2B.

Referring to FIGS. 2A, 3B and 12A, in this embodiment the first rail 204 of the chassis 200 includes a front retention guide 296 and a rear retention guide 297, disposed at a front end and at a rear end of the first rail 204, respectively. Similarly, the second rail 206 also includes a front retention guide 298 and a rear retention guide 299, disposed at a front end and at a rear end of the second rail 206, respectively. In this embodiment, each of the retention guides 296, 297, 298 and 299 includes an elevated retention tab. More particularly, in this embodiment each retention tab has a sloped or tapered upper surface, ranging from a maximum height at the tab's outmost edge adjacent the outer extrusion frame of the removable trimming module 300, to a minimum height at the tab's innermost edge (where the height of the rail 204 drops back down to the rail's median length). In this embodiment, the front retention guide 296 of the first (left) rail 204 defines a rear-facing L-shaped front guide bracket 303 at its innermost edge, and likewise, the rear retention guide 297 of the first rail 204 defines a front-facing L-shaped rear guide bracket 305 at its innermost edge. In this embodiment, the L-shaped guide brackets 303 and 305 are shaped, sized, and spaced apart, to snugly but removably receive the left edges of the L-shaped front support leg 302 and of the rear support leg 304 of the removable trimming module 300 therein. Likewise, the front and rear retention guides 298 and 299 of the second rail 206 form similar L-shaped guide brackets to snugly but removably receive the right edges of the L-shaped front support leg 302 and rear support leg 304 of the removable trimming module 300 therein.

Advantageously, the above structures effectively enable passive self-centering of the removable trimming module 300 within the chassis 200. To install the removable trimming module 300 into the chassis for operation, a user need do nothing more than carefully lower the removable trimming module 300 into the chassis 200. If the user does not perfectly center the module 300 in the chassis 200 as the module is being lowered, then whichever of the L-shaped support legs 302 and 304 is horizontally too far outward from the center of the chassis will be positioned above retention guides, instead of being correctly positioned above the L-shaped guide brackets 303 and 305 defined by the first rail 204 and the similar guide brackets of the second rail 206. As the off-centre trimming module 300 is lowered into the chassis, whichever L-shaped support leg 302 or 304 is too far outward will bear down upon the sloping upper surface of one or more of the retention guides 296-299, causing that support leg to slide downward and inward along the upper surface of the retention guide, until it reaches the innermost edge of the retention guide, at which point the support leg 302 or 304 drops down into the L-shaped guide bracket 303 or 305 defined by the first rail 204, and the counterpart guide bracket defined by the second rail 206.

Referring to FIGS. 4B, 17A-17F and 18, it was noted above that the support legs 302 and 304 of the removable trimming module were formed by lower L-shaped portions of unibody end plates.

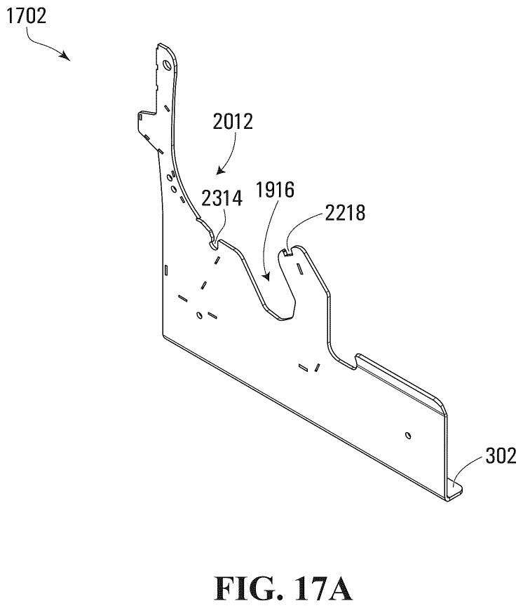

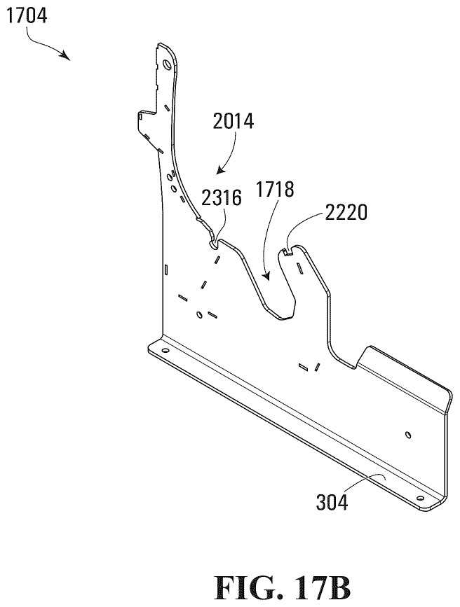

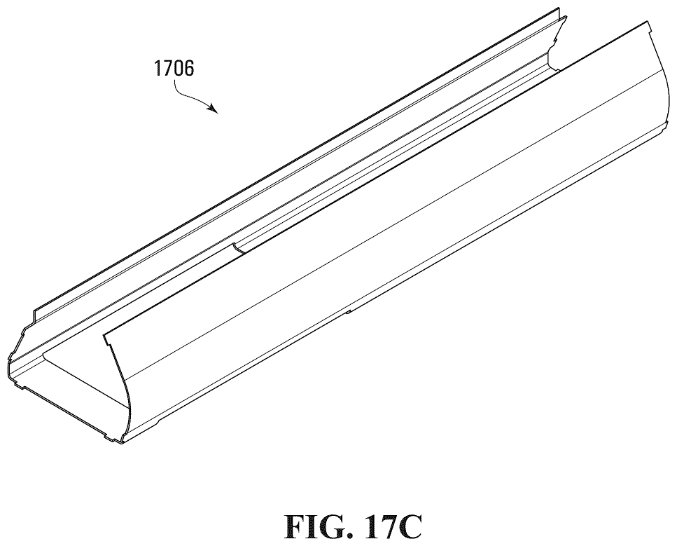

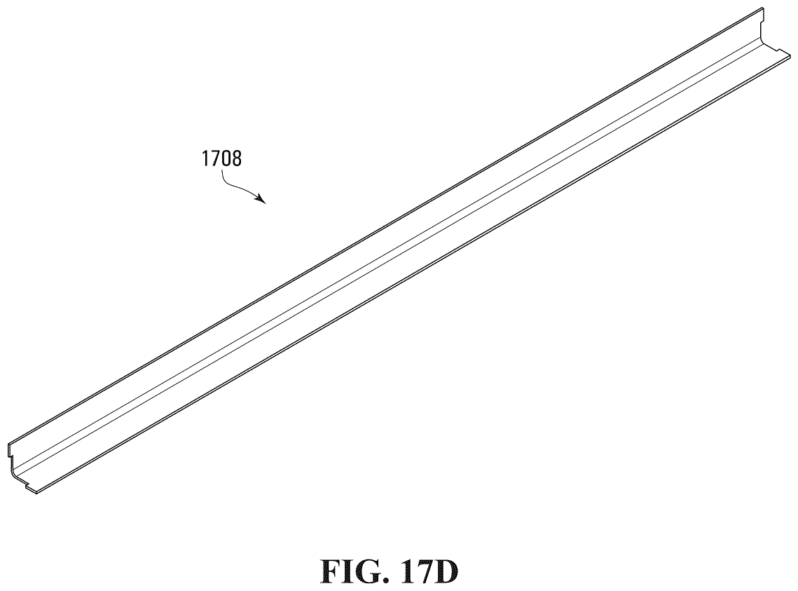

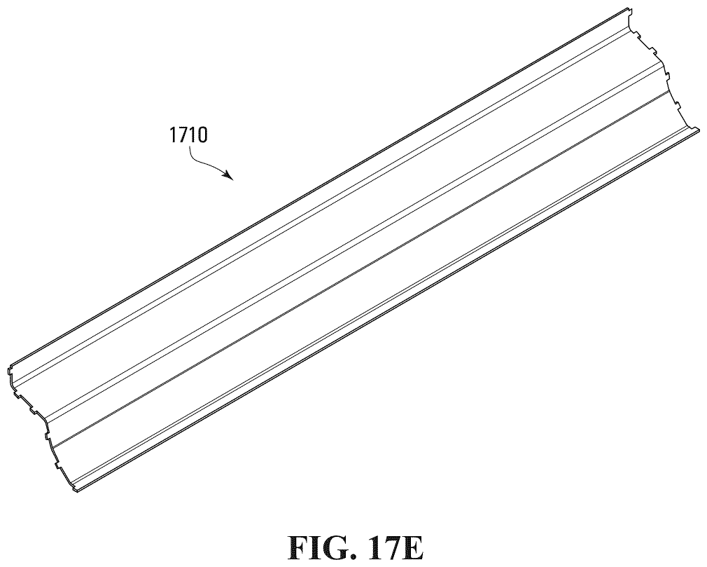

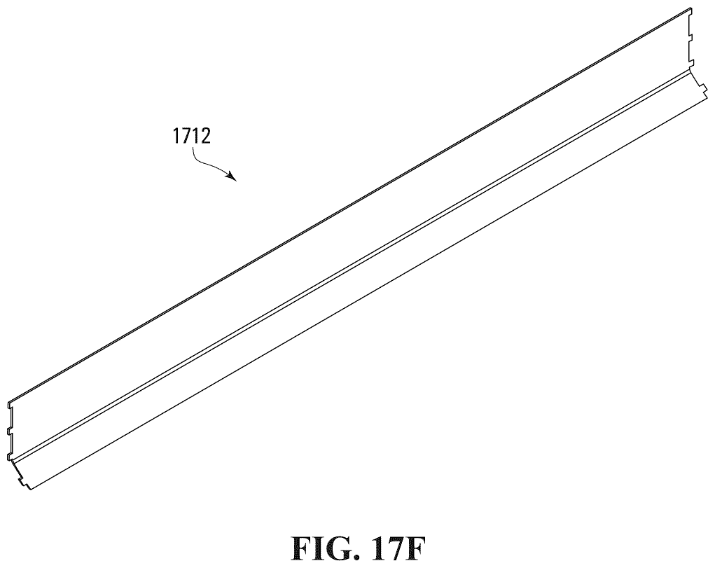

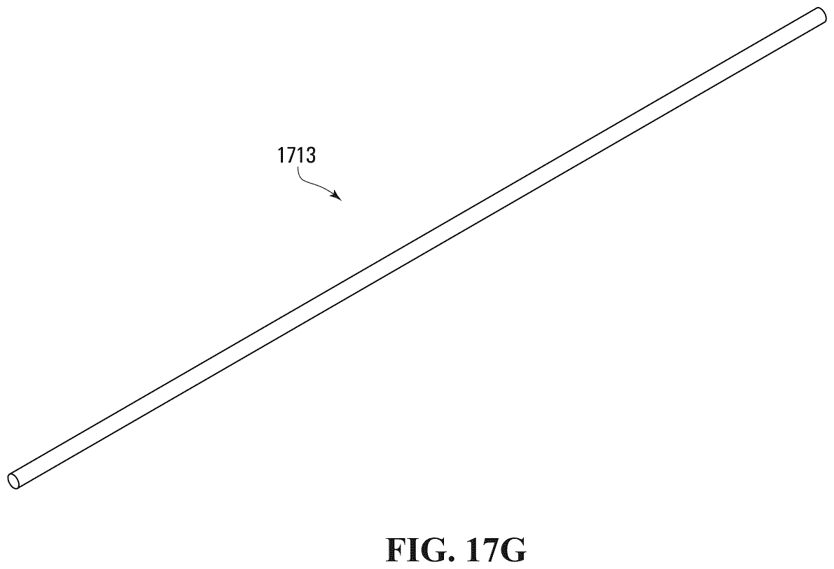

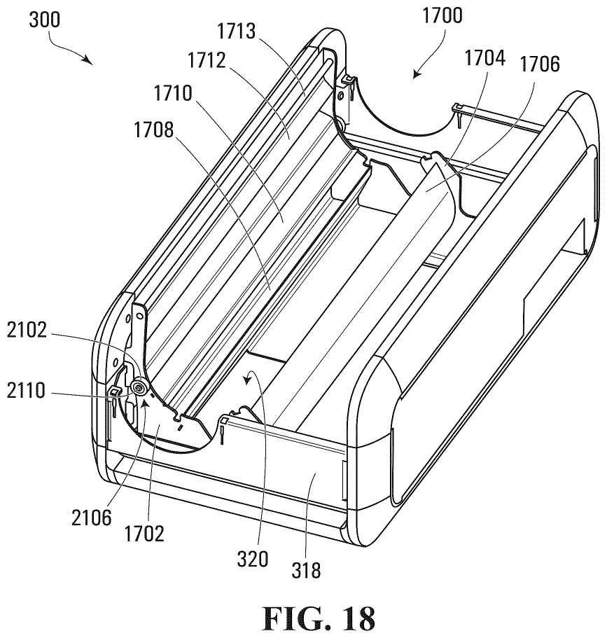

In this embodiment the removable trimming module 300 includes a unibody structure 1700 shown assembled in FIG. 18 from unibody components shown in FIGS. 17A-17G. More particularly, the unibody structure includes a front unibody plate 1702 shown in FIG. 17A that includes the front support leg 302, a rear unibody plate 1704 shown in FIG. 17B that includes the rear support leg 304, a unibody reel cover 1706 shown in FIG. 17C, a unibody bottom cross brace 1708 shown in FIG. 17D, a unibody middle cross brace 1710 shown in FIG. 17E, a unibody bottom top brace 1712 shown in FIG. 17F, and a tumbler retaining rod 1713 shown in FIG. 17G. As generally shown in FIGS. 4B and 18, each one of the unibody reel cover 1706, the three unibody cross braces 1708, 1710 and 1712, and the tumbler retaining rod 1713, is connected at its front end to the front unibody plate 1702, and is connected at its rear end to the rear unibody plate 1704. In this embodiment, unless indicated otherwise herein, these connections include tab-and-slot connections, with tabs protruding from the reel cover and cross-braces that are engageable in slots defined through the front and rear unibody plates 1702 and 1704. Alternatively, other types or methods of connection may be substituted.

In this embodiment, the unibody structure is connected to an extrusion frame of the removable trimming module 300. More particularly, in this embodiment the front unibody plate 1702 is bolted to a lower front extrusion crossbar 314 by first and second bolts 1714 and 1716, with each bolt connection having a spacer (not shown in FIG. 4B but identical to those shown at 1718 and 1720 in FIG. 4B on the opposite side) interposed between the front unibody plate 1702 and the lower front extrusion crossbar 314. Similarly, in this embodiment the rear unibody plate 1704 is bolted to a lower rear extrusion crossbar 316 using bolts identical to those shown on the opposite side at 1714 and 1716, extending through the rear unibody plate 1704 and through spacers 11718 and 1720 interposed between the rear unibody plate 1704 and the lower rear extrusion crossbar 316.

Referring to FIGS. 18-23, in this embodiment the unibody structure 1700 is configured to permit relatively easy installation and removal of various components and assemblies of the removable trimming module.

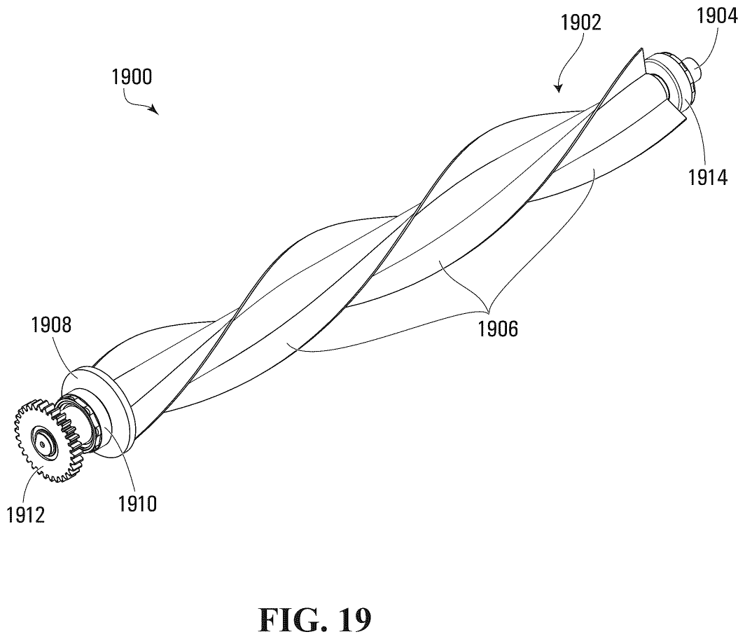

For example, referring to FIG. 19, a helical-bladed cutting reel assembly is shown generally at 1900. In this embodiment the assembly 1900 includes a helical-bladed cutting reel 1902 having a solid central shaft 1904 and a plurality of helical cutting blades 1906 welded directly to the shaft, as described in the Applicant's issued U.S. Pat. No. 10,906,047. At a front end of the shaft 1904, an anti-dive disc 1908 is mounted to the shaft 1904 immediately adjacent the forward ends of the helical blades 1906. A front bearing 1910 is mounted to the shaft 1904 forward of the anti-dive disc 1908, and a driven gear 1912 is mounted to the shaft forward of the bearing, in mechanical communication with the cutting reel. At a rear end of the shaft 1904, a bearing 1914 is mounted to the shaft 1904.

Referring to FIGS. 17A-19, to install the helical-bladed cutting reel assembly 1900 in the removable trimming module 300, the assembly 1900 is lowered or inserted into the unibody structure 1700, with the front bearing 1910 fitting into a reel slot or hole 1716 defined in the front unibody plate 1702, and the rear bearing 1914 fitting into a reel slot or hole 1718 defined in the rear unibody plate 1704. The driven gear 1912 is positioned just outside the unibody structure, in a space between the front unibody plate 1702 and a front side plate 318 of the trimming module.

Referring to FIGS. 17A-18 and 23, a helical pan assembly is shown generally at 2300. In this embodiment, the helical pan assembly 2300 includes a front right roller cam 2302 and a rear right roller cam 2304, for supporting a right side of the tumbler 2002 while it rotates. More particularly, in this embodiment the helical pan assembly includes a front plate 2306 and a rear plate 2308, with an elongated helical pan plate 2310 mounted between the front and rear plates 2306 and 2308. In this embodiment, the front right roller cam is rotationally mounted to the front plate 2306, while the rear right roller cam 2304 is rotationally mounted to the rear plate 2308, to allow each of the roller cams 2302 and 2304 to rotate freely about its axis while preventing translational motion of the roller cams.

Referring to FIGS. 17A-B and 23, the helical pan assembly includes a lower front dowel pin 2312 extending from a lower portion of the front plate 2306, configured to fit into a corresponding slot 2314 defined in the front unibody plate 1702. A similar lower rear dowel pin (not shown) extends from the rear plate 2308 and is configured to fit into a corresponding slot 2316 defined in the rear unibody plate 1704. Accordingly, the helical pan assembly can be installed by lowering it into place and slotting the lower front and lower rear dowel pins into their corresponding slots (e.g. 2314) defined in the front and rear unibody plates.

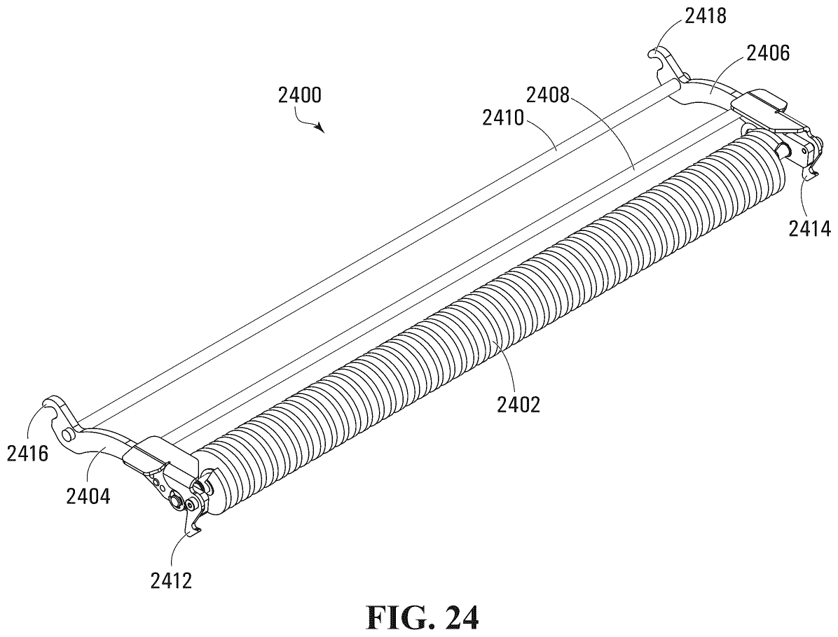

In this embodiment, the helical pan assembly 2300 also includes an upper front dowel pin 2318 extending forward from the front plate 2306, and an upper rear dowel pin 2320 extending rearward from the rear plate 2308, both for connecting the helical pan assembly 2300 to a brush assembly 2400 shown in FIG. 24.

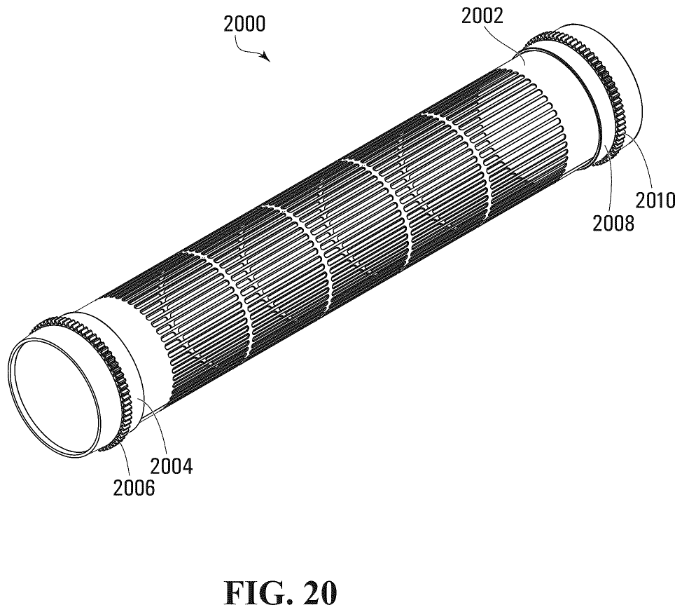

Referring to FIGS. 17A-18 and 20, a tumbler assembly is shown generally at 2000 in FIG. 20. In this embodiment, the tumbler assembly 2000 includes a sheet metal tumbler 2002 having a front end cap 2004 including a gear 2006, and a rear end cap 2008 including a driven gear 2010 in mechanical communication with the tumbler 2002.

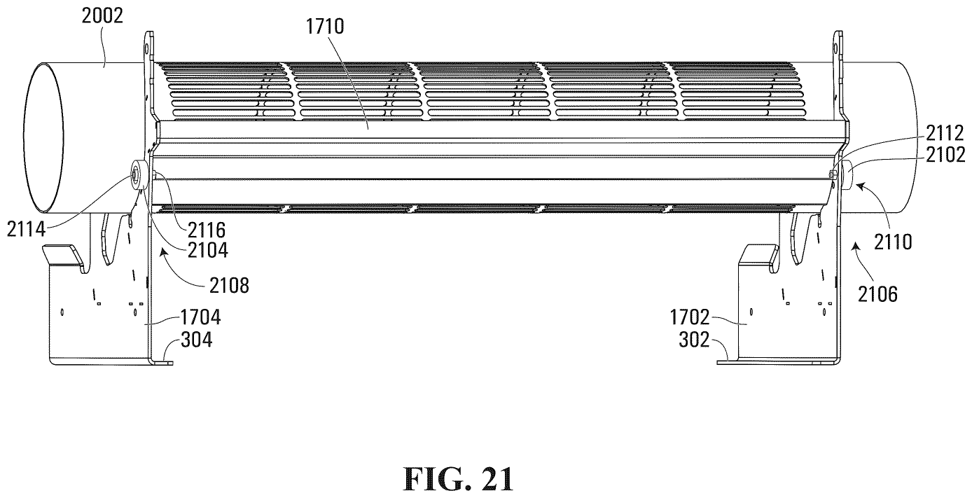

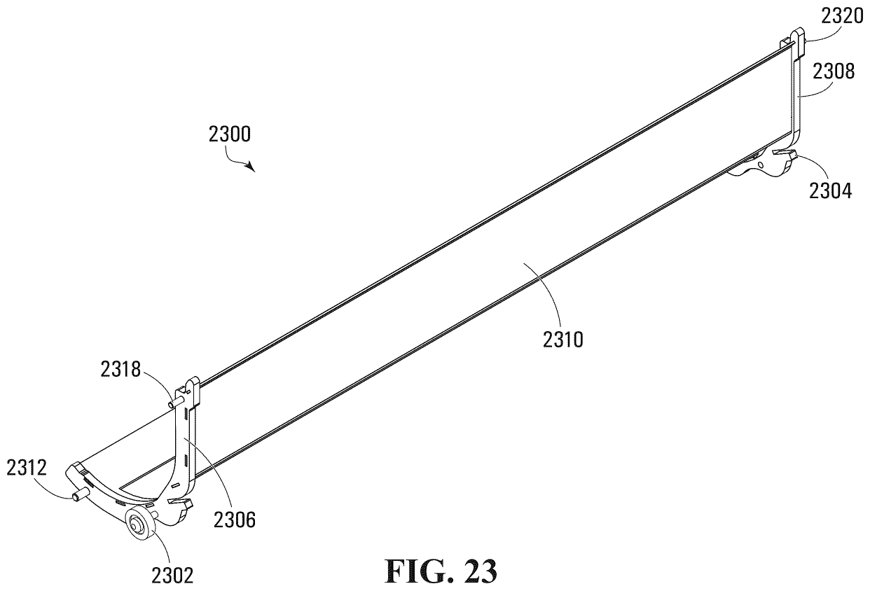

To position the tumbler assembly 2000 in the removable trimming module 300, the tumbler assembly is lowered into tumbler recesses 2012 and 2014 that are respectively defined in the front and rear unibody plates 1702 and 1704 shown in FIGS. 17A-B. In operation, the tumbler 2002 does not rest directly upon the unibody plates 1702 and 1704 themselves. Instead, referring to FIG. 21, in this embodiment a left side of the tumbler rests on a left front roller cam 2102 and a left rear roller cam 2104 connected to the front and rear unibody plates 1702 and 1704, respectively, immediately to the left of the unibody middle cross brace 1710. Referring also to FIG. 23, a right side of the tumbler rests on a right front roller cam 2302 and a right rear roller cam 2304 of a helical pan assembly 2300.

In this embodiment, the unibody structure 1700 is equipped with adjustable tumbler guides to adjust a spacing between the tumbler and the cutting reel and knife assemblies. More particularly, a first tumbler guide is shown generally at 2106 in FIGS. 18 and 21, and includes the left front roller cam 2102, mounted to the front unibody plate 1702 by a bolt 2110 extending through the roller cam 2102 and through the unibody plate 1702 into a nut 2112. Similarly, a second tumbler guide is shown generally at 2108 and includes the left rear roller cam 2104, mounted to the rear unibody plate 1704 by a bolt 2114 extending through the roller cam 2104 and through the unibody plate 1704 into a nut 2116. In this embodiment, each of the nuts 2112 and 2116 is an offset, eccentric hex nut whose hexagonal body is not symmetric about the central axis of its central bolt hole (or in other words, the central bolt hole is offset from the axial center of the nut). When installed, each of the nuts 2112 abuts directly against a left side of the unibody middle cross brace 1710, so that the nuts cannot rotate relative to the front unibody plate 1702 or the rear unibody plate 1704. Consequently, rotation of the bolts 2110 and 2114 through a fraction of a turn will move the roller cam's offset axis of rotation, thereby slightly increasing or decreasing the offset distance between the tumbler 2002 and the unibody middle cross brace 1710, and thereby also slightly adjusting the spacing between the tumbler and the knife and cutting reel assemblies.

Referring to FIGS. 17A-B, 23 and 24, a brush assembly is shown generally at 2400. In this embodiment, the brush assembly 2400 includes a rotatable brush 2402, rotationally mounted between a front tumbler retainer plate 2404 and a rear tumbler retainer plate 2406, so that the brush 2402 can rotate about its axis while mounted to these two plates. In this embodiment, the front and rear tumbler retainer plates 2404 and 2406 are also connected to each other by first and second tumbler retaining rods 2408 and 2410.

In the present embodiment, the brush assembly 2400 further includes a front retainer latch 2412 and a rear retainer latch 2414. Referring also back to FIG. 23, in this embodiment the front retainer latch 2412 is an interference latch configured to latch onto or release the upper front dowel pin 2318 of the helical pan assembly 2300, while the rear retainer latch 2414 is an interference latch configured to latch onto or release the upper rear dowel pin 2320 of the helical pan assembly 2300. Also in this embodiment, the front tumbler retainer plate 2404 includes a hook 2416, and the rear tumbler retainer plate 2406 similarly includes a hook 2418. In this embodiment, the hooks 2416 and 2418 are configured to hook onto the tumbler retaining rod 1713 of the unibody structure 1700 shown in FIG. 17A-18. Accordingly, when the helical pan assembly 2300 is in place, the brush assembly 2400 can be easily removed by actuating the interference latches 2412 and 2414 to detach the brush assembly 2400 from the upper dowel pins 2318 and 2320, and lifting the brush assembly 2400 to unhook it from the tumbler retaining rod 1713 of the unibody structure 1700. Installation involves lowering the brush assembly into place, to connect the interference latches 2412 and 2414 to the upper dowel pins 2318 and 2320 of the helical pan assembly 2300, and to hook the hooks 2416 and 2418 onto the tumbler retaining rod 1713 of the unibody structure 1700.

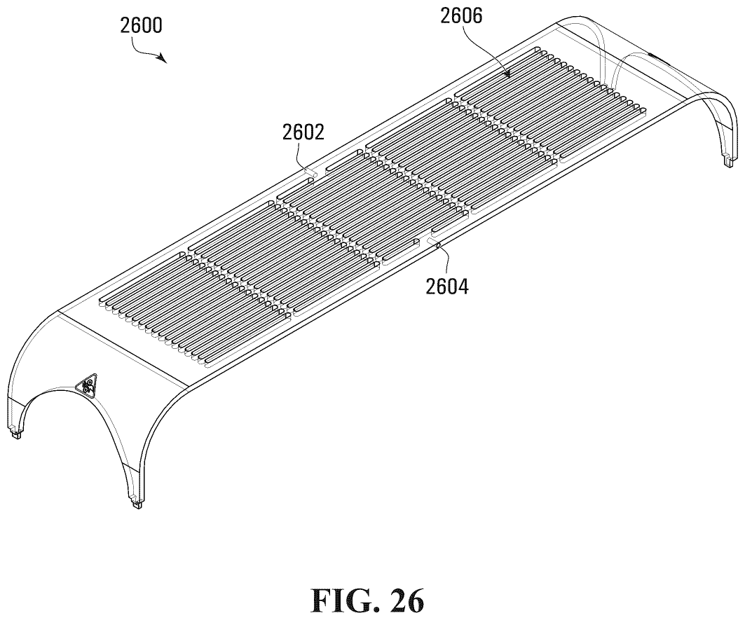

Referring to FIGS. 3 and 26, in this embodiment the removable trimming module 300 further includes a cover 2600 having detection indicia. More particularly, in this embodiment the cover 2600 is a reversible transparent polycarbonate cover, and the detection indicia comprise first and second magnets 2602 and 2604 disposed on symmetrically opposite left and right sides of the cover 2600.

In this embodiment, the cover 2600 also has angled louvres shown generally at 2606 defined through its top surface, configured to maximize air flow while minimizing spillage of debris.

### Flexible Knife Assembly

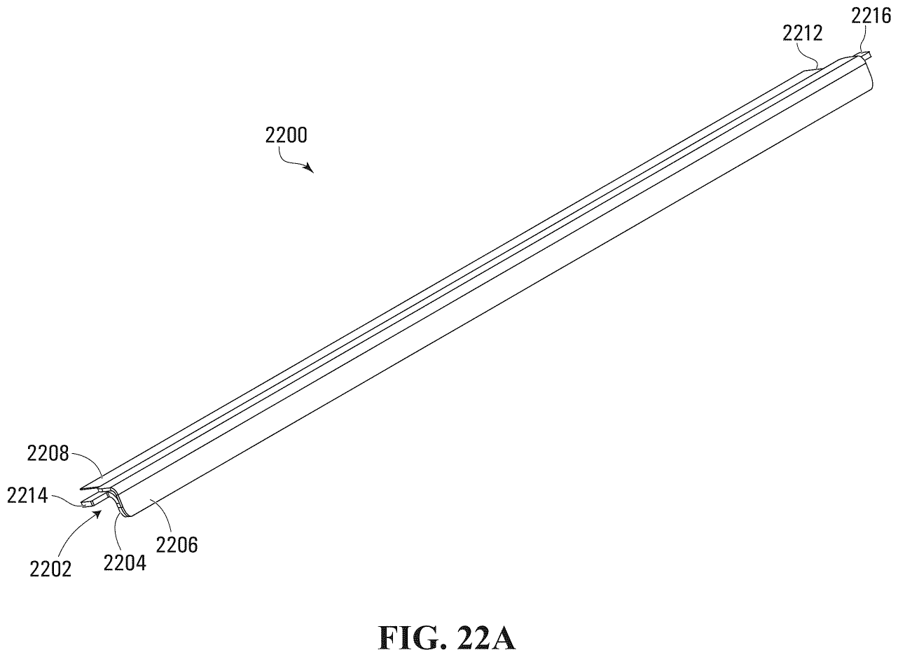

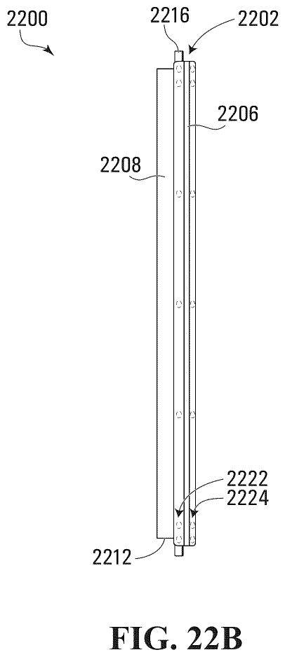

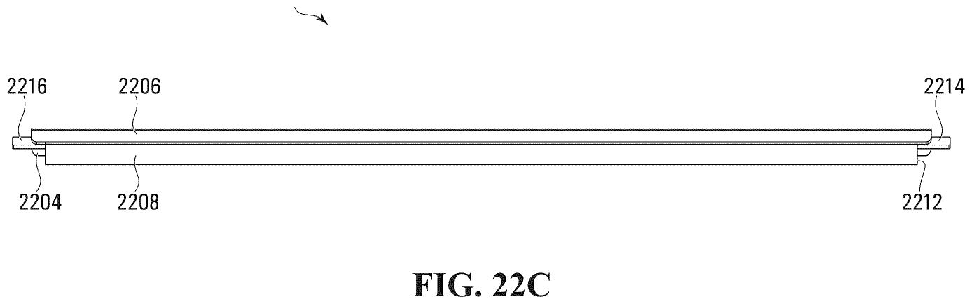

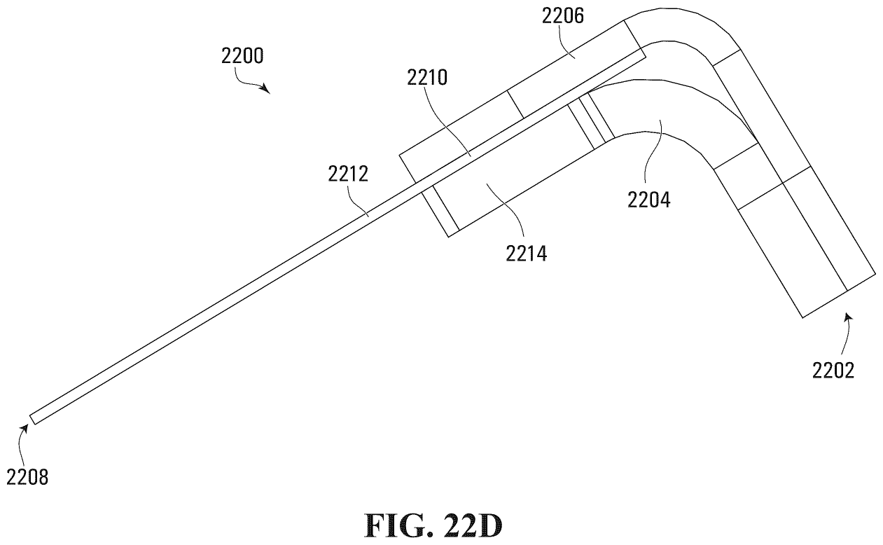

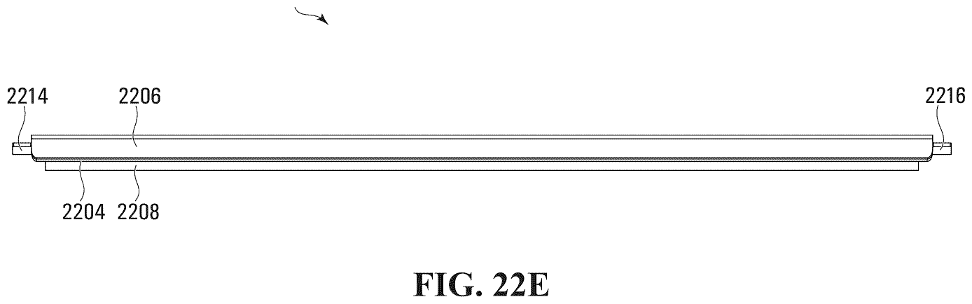

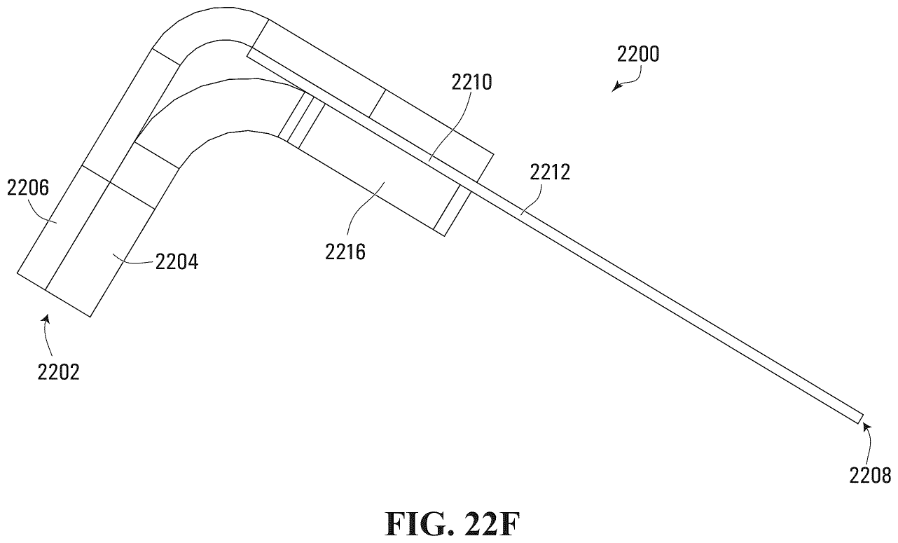

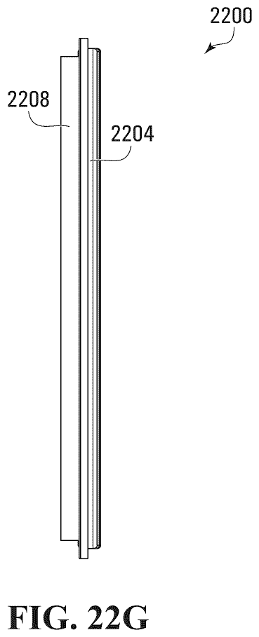

A bed knife assembly for the trimming machine 100 of the present embodiment is shown generally at 2200 in FIGS. 22A to 22G. The knife assembly 2200 includes a knife holder 2202, which in this embodiment includes a knife holder assembly. More particularly, in this embodiment the knife holder 2202 includes a knife holder base 2204 and a knife holder cap 2206.

In this embodiment, the knife assembly 2200 further includes a knife blade 2208. The knife blade 2208 includes a secured portion 2210 secured within the knife holder 2202, sandwiched between the base 2204 and the cap 2206. The knife blade 2208 further includes a flexible unsecured portion 2212 extending outward from the knife holder 2202 by a sufficient distance to permit the flexible unsecured portion 2212 of the knife blade 2208 to flex during operation. In this embodiment, the knife blade 2208 is pre-loaded with a sufficient pre-load force applied between the bed knife assembly 2200 and a helical-bladed cutting reel 1902 to deform the knife blade 2208.

More particularly, in this embodiment the pre-load force deforms the knife blade 2208 to bend at least partly into a cylindrical region within which the cutting reel 1902 spins. The cylindrical region is bounded by a cylindrical outer surface on which lie the radially outermost edges of a plurality of helical cutting blades 1906 of the cutting reel 1902, relative to the central axis of a central shaft 1904 of the cutting reel 1902.

In this embodiment, as the pre-load force urges the knife blade 2208 into this cylindrical region, the knife blade 2208 begins to contact the helical cutting blades 1906 at multiple points or contact patches along its length, with the number of such contact patches depending on the number of helical blades 1906 and their helicities. In this embodiment the helical cutting blades 1906 are rigid, much more so than the flexible knife blade 2208. Consequently, as the pre-load force urges the knife blade 2208 into this cylindrical region in which helical blades spin, this forces the flexible knife blade 2208 to deform at each of the contact patches by bending out of the way to accommodate the presence of the comparatively rigid helical cutting blade. In between the contact patches, the flexible knife blade 2208 is able to bend more deeply into the cylindrical region within which the cutting reel 1902 spins.

Advantageously, this tends to achieve better contact between the knife blade 2208 and the helical blades 1906 along more of the knife blade's length, effectively creating longer contact patches between the knife blade 2208 and each of the rotating helical blades 1906 as they spin past the knife blade. This tends to improve trimming efficiency by trimming more undesired plant material per reel rotation.

In the present embodiment, the pre-loading is achieved with the co-operation of the removable power pack module 500, as discussed below following descriptions of the knife blade assembly and of the power pack module.

In this embodiment the flexible unsecured portion 2212 of the knife blade 2208 extends outward at least three quarters of an inch from the knife holder 2202. More particularly, in this embodiment the flexible unsecured portion 2212 extends about one inch outward from the knife holder 2202. In another illustrative embodiment, the flexible unsecured portion 2212 extends about two inches outward from the knife holder 2202. In another group of illustrative embodiments, the flexible unsecured portion 2212 extends outward from the knife holder 2202 by a distance in the range from three quarters of an inch to two inches. In another illustrative embodiment, the flexible unsecured portion 2212 extends at least two inches from the knife holder 2202. Advantageously in such embodiments, the knife blade is more flexible, and tends to maintain better contact with the helical cutting reel blades along even longer contact patches, thereby resulting in further improvements in trimming efficiency.

Alternatively, in other embodiments, the flexible unsecured portion 2212 of the knife blade 2208 may extend outward from the knife holder 2202 by smaller distances, such as one-half inch or one-quarter inch, for example. With pre-loading of the knife blade as described herein, improvements in trimming efficiency over conventional trimming machines may be achievable even with blades that extend by shorter, more conventional lengths, especially (though not exclusively) if the thickness of the knife blade 2208 is varied.

In this embodiment, the knife blade 2208 is composed of 716 stainless steel, and has a thickness of 25 mils (25 thousandths of an inch). Alternatively, blades of different materials or thicknesses may be substituted. Typically, thinner blades tend to be more flexible, which can be advantageous to a point, subject to trade-offs such as increased wear and shortened service lifetime of the blade.

In this embodiment, due to the unusually large outward extent of the flexible unsecured portion 2212, the knife blade 2208 tends to be more flexible than previous knife blades, even in comparison to the applicant's own prior flexible knife blades such as those disclosed in the Applicant's issued U.S. Pat. No. 10,842,080, for example. Consequently, the knife blade 2208 tends to maintain better contact with the helical blades of the cutting reel along more of its length and for longer time periods in its cycles, thereby improving the quality and efficiency of the scissor-action cutting of plant material protruding outward through the slots in the tumbler.

In this embodiment, the knife holder 2202 includes first and second mounting tabs 2214 and 2216 at opposite ends of the knife holder 2202, each of the mounting tabs extending longitudinally beyond a respective opposite end of the flexible unsecured portion 2212 of the knife blade 2208 and being configured to engage in respective first and second mounting slots of the trimming machine.

More particularly, referring to FIGS. 17A-B and 22A-G, in this embodiment the first and second mounting slots of the trimming machine 100 include a front mounting slot 2218 defined in the front unibody plate 1702 shown in FIG. 17A, and a rear mounting slot 2220 defined in the rear unibody plate 1704 shown in FIG. 17B. In this embodiment, the first mounting tab 2214 includes a first ear protruding forward from a front end of the knife holder 2202, shaped and configured to securely fit in the forward mounting slot 2218. Similarly, in this embodiment the second mounting tab 2216 includes a second ear protruding rearward from a rear end of the knife holder 2202, shaped and configured to securely fit in the rear mounting slot 2220.

In this embodiment, each of the mounting tabs 2214 and 2216 is integrally formed with at least one of the base 2204 and the cap 2206. More particularly, in this embodiment each of the mounting tabs 2214 and 2216 is integrally formed with the base 2204. Alternatively, each of the mounting tabs may be integrated with only the cap 2206, with neither the cap nor the base, or with both the cap and the base.

In some embodiments, the knife blade 2208 may be welded between the base 2204 and the cap 2206 by capacitive discharge welding. For example, as shown in broken outline in FIG. 22B (top view) only, the knife assembly 2200 may further include a plurality of weld spots 2222 defined in each of the base 2204, the cap 2206 and the secured portion 2210 of the knife blade 2208, which secure the secured portion 2210 of the knife blade 2208 between the base 2204 and the cap 2206. Likewise, the knife assembly 2200 may further include a plurality of weld spots 2224 defined in each of the base 2204 and the cap 2206, that secure the base 2204 to the cap 2206. In this embodiment, the weld spots 2222 and 2224 are formed by capacitive discharge welding. Alternatively, other types of welding, or more generally other ways of fixing or bonding the knife blade 2208 within the knife holder 2202 may be substituted.

Regarding the weld spots 2222, in embodiments such as the present embodiment, in which the portions of the base 2204 and of the cap 2206 that sandwich the secured portion 2210 of the blade 2208 between them (i.e., the portions on the upper left side of the knife holder 2202) are longer than the blade 2208 itself, those same portions may nevertheless be welded together at their outer end regions where the blade 2208 has terminated and is no longer present between the base and the cap. If so, a shim of blade stock material having the same thickness and preferably the same material as the blade 2208 may be inserted between the base and the cap at the weld point, to maintain constant spacing and parallel alignment between the base and the cap along their entire length.

Conversely, regarding the weld spots 2224, the portions of the base 2204 and the cap 2206 that lie on the right side of the knife holder 2202, may be welded directly together with neither any blade nor other material between them.

Advantageously, capacitive discharge welding, if used in a particular embodiment, does not require the insertion of filler material between the surfaces being welded together, thereby allowing for a tighter fit between welded components. Additionally, capacitive discharge welding provides more effective focusing of its energy upon the spots to be welded, which tends to reduce the amount of heat needed to weld the two surfaces together, which in turn reduces the tendency of the welded surfaces to permanently warp or otherwise deform under thermal stress and expansion. Alternatively, different ways of securing the knife blade may be substituted in other embodiments.

In this embodiment, each of the base 2204 and the cap 2206 includes a stainless steel alloy. Also in this embodiment, the knife blade 2208 includes a second stainless steel alloy different than the stainless steel alloy of the base 2204 and the cap 2206. In this embodiment the base 2204 and the cap 2206 comprise 304 stainless steel, whereas the knife blade 2208 comprises 716 stainless steel. Alternatively, other alloys may be substituted for the base and the cap, such as 316 stainless, for example.

### Removable Power Pack and Pre-Loading of Knife Blade

Referring back to FIGS. 3-5, the removable power pack module is shown generally at 500. In this embodiment, the removable power pack module 500 is receivable in the chassis 200, and includes at least one drive motor for rotating the tumbler 2002 and the cutting reel 1902. In this embodiment, the removable power pack assembly 500 is configured to rest in the chassis 200 during operation.

From one perspective, in this embodiment the removable power pack module 500 is indirectly receivable in the chassis 200: as discussed in greater detail above, the entire removable trimming module 300 is removably receivable in the chassis 200, and the removable power pack module 500 is removably receivable in the removable trimming module 300.

From another perspective however, the chassis 200 may be seen as one part of a larger chassis, which includes both a lower chassis and an upper chassis removably mountable atop the lower chassis. More particularly, the lower chassis includes the chassis 200, and the upper chassis includes the removable trimming module 300, including its extrusion frame, configured to support the tumbler, the cutting reel and the knife assembly. In this embodiment, the removable power pack 500 is removably receivable in the larger chassis, as it is receivable in the upper chassis defined by the removable trimming module 300. Alternatively, in other embodiments the removable power pack module 500 may be receivable directly in the chassis 200 if desired.

In this embodiment, the removable power pack module 500 includes a housing 502, including a front plate 504 and a rear plate 506. The housing 502 further includes a lower extrusion 508 that forms a floor and lower left and right sidewalls of the housing 502, and an upper extrusion 510 that forms a roof and upper left and right sidewalls of the housing 502. In this embodiment, the upper extrusion 510 is bolted to both the front plate 504 and the rear plate 506, and likewise, the lower extrusion 508 is also bolted to both the front plate 504 and the rear plate 506.

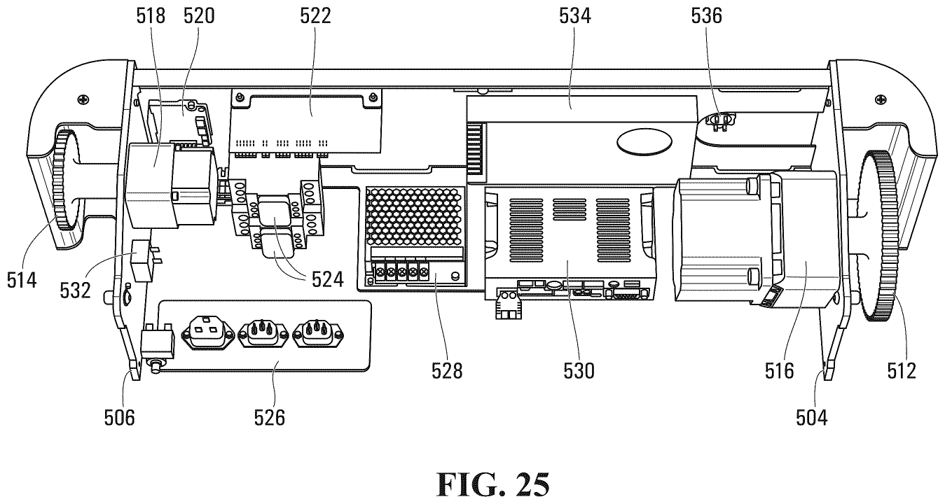

Referring to FIGS. 5 and 25, FIG. 25 shows the removable power pack module 500 with the upper extrusion 510 and the lower extrusion 508 removed, for ease of illustration. In this embodiment the removable power pack module 500 includes both a front driving gear 512 and a rear driving gear 514. In this embodiment the two driving gears are powered by different electric motors: a reel motor 516 includes a drive shaft and a front driving gear 512 extending radially outward from the drive shaft of the reel motor, and a tumbler motor 518 includes a drive shaft and a rear driving gear 514 extending radially outward from the drive shaft of the tumbler motor. The reel motor 516 includes a 400 W brushless DC motor for powering the rotation of the helical-bladed cutting reel 1902. The tumbler motor 518 includes a 30 W brushless DC motor for powering the rotation of the tumbler 2002. Alternatively, the removable power pack module 500 may drive the rotation of only a single output driving gear, or more than two output driving gears, and if desired, a single motor may drive more than one driving gear.

In this embodiment, the removable power pack module 500 includes all of the electronic and electrical components that are required to drive the tumbler 2002 and the cutting reel 1902 of the removable trimming module 300. By way of example, in this embodiment the removable power pack module 500 includes a motor driver 520 to drive the tumbler motor 518, a main control board 522, contactors 524, an electrical input/output panel 526, a 24V DC power supply 528, a motor driver 530 for the reel motor 516, an hours timer 532, a 48V DC power supply 534, and an emergency stop switch 536. Advantageously, cleaning of the removable trimming module 300 is greatly facilitated by the fact that all of the electrical and electronic components that power the cutting reel, tumbler and cleaning brush are housed within the removable power pack module 500. The removable power pack module 500 can simply be removed, and since the removable trimming module 300 does not contain any other electronic components or electrical connections, the trimming module 300 can be pressure washed.

Referring to FIGS. 3b,4B, 5, 17A-B and 25, in this embodiment the removable power pack module 500 can be installed in the removable trimming module 300 by simply lowering the power pack module 500 into the trimming module 300. In this embodiment, the spacing between the front plate 504 and the rear plate 506 of the power pack shown in FIG. 25 corresponds to the spacing between the front unibody plate 1702 and the rear unibody plate 1704. Accordingly, the removable power pack module may be lowered into the trimming machine, until the bottom surfaces of the front and rear plates 504 and 506 of the power pack module contact and rest upon the upward-facing surfaces of the legs 302 and 304 formed by the lower portions of the trimming module's front unibody plate 1702 and rear unibody plate 1704.

In this embodiment, the removable power pack assembly 500 is configured to rest on the bed knife assembly 2200 of the trimming machine 100 when the removable power pack module 500 is received in the chassis 200, to secure the bed knife assembly 2200 in position for operation.

More particularly, referring to FIGS. 18 and 25, in this embodiment, the removable power pack module 500 pre-loads the knife blade 2208 with a significant pre-load force, to press the knife blade 2208 against the helical cutting reel 1902 with a sufficient force to flex and bend the knife blade 2208. To achieve this, in this embodiment the removable power pack module is configured to rest on the bed knife assembly 2200 to secure the bed knife assembly abutting the helical bladed cutting reel 1902 with a pre-load force applied therebetween.

As shown in FIG. 18, as the removable power pack module 500 is progressively lowered into the removable trimming module 300, a bottom left edge of the removable power pack module begins to abut and push against the reel cover 1706, which slopes downward and to the right to occupy some of the volume required by the removable power pack module. As the removable power pack module 500 is lowered all the way down, it pushes the reel cover 1706 to the left and out of its way, and because the reel cover 1706 is connected to the front unibody plate 1702 and the rear unibody plate 1704, the downward action of the removable power pack module 500 tends to apply a torque to the unibody structure 1700, thereby forcing the front mounting slot 2218 defined in the front unibody plate 1702 and the rear mounting slot 2220 defined in the rear unibody plate 1704 to move to the left. Since the mounting tabs 2214 and 2216 of the knife assembly 2200 are mounted in the front and rear mounting slots 2218 and 2220, this effectively forces the knife blade 2208 to the left, causing it to abut against the helical blades of the cutting reel 1902 with considerable pre-load force, sufficient to deform the flexible knife blade 2208 to maximize contact between the knife blade 2208 and the helical blades of the cutting reel. This tends to force the knife blade 2208 deeper into a cylindrical volume in which the helical cutting blades 1906 spin, defined by the radially outer surfaces of the helical cutting blades. Advantageously, this tends to lengthen the contact patches between the helical cutting blades and the knife blade as the helical blades spin past the knife blade, thereby providing a closer and more efficient cutting action than conventional rigid-bladed systems, or even in comparison to the applicant's own previous flexible-bladed systems, which lacked pre-loading.

In this embodiment, at least one drive motor of the removable power pack module 500 is biased primarily by gravity to engage with and drive rotation of the tumbler 2002 and the cutting reel 1902.

For example, referring to FIG. 3C, when the removable power pack module 500 is lowered into the removable trimming module 300, the force of gravity acting upon the removable power pack module 500 is sufficient to lock the front driving gear 512 of the removable power pack module 500 into engagement with the driven gear 1912 of the cutting reel assembly 1900 of the removable trimming module 300, to allow the reel motor 516 to drive the rotation of the helical cutting reel 1902.

Similarly, referring to FIG. 3D, the force of gravity acting upon the removable power pack module 500 is sufficient to lock the rear driving gear 514 of the removable power pack module 500 into engagement with the driven gear 2010 of the tumbler 2002, to allow the tumbler motor 518 of the removable power pack module 500 to drive the rotation of the tumbler 2002.

Thus, in this embodiment, the driving gears 512 and 514 are biased only by gravity to engage with the driven gears 1912 and 2010 respectively, to drive rotation of the cutting reel 1902 and of the tumbler 2002.

### Assembly and Disassembly

It will be appreciated from the foregoing description that the trimming machine 100 is designed to be easily disassembled and reassembled by hand without requiring the use of tools, whether for maintenance, repairs or otherwise.

For example, to dismantle the assembled plant trimming machine 100, a user would first disconnect the removable power pack module 500 from any external power supply, then remove the power pack module from the removable trimming module 300 by simply lifting the power pack module up vertically out of the trimming module. Advantageously, this step alone effectively readies the machine 100 for cleaning. When the power pack module 500 has been removed, the trimming module 300 contains no electronic or electrical components and can therefore be pressure-washed. Among the other components of the trimming machine 100, only the fan motor 636 has an electrical connection, but in this embodiment the fan motor 636 is sealed and can be washed, either in situ or when removed from the trimming machine.

Further dismantling may continue by removing the removable trimming module 300 from the machine 100, which in this embodiment is accomplished by simply lifting the removable trimming module 300 vertically upward out of the chassis 200.

Next, the user may unlock the remaining components housed in the chassis by grabbing the handle 628 of the removable fan motor module 600 shown in FIG. 6A, and lifting up on the handle 628. This will move the roller bearings 632 and 634 along a downward and inward arcuate path, thereby moving the roller bearings 632 and 634 out of engagement with the fourth upper crossbar 254, and effectively unlocking the fan motor module 600 to allow it to slide rearward along the rails 204 and 206 within the chassis 200. The user may then slide the fan motor module 600 rearward to unlock the hooks 212 and 214 from the slots 616 and 618, at which point the fan motor module 600 may be removed by lifting it vertically upward off the rails 204 and 206 and out of the chassis 200.

The user may then similarly remove the fan blade housing module 700 by lifting it upward off the rails 204 and 206 and out of the chassis 200. Likewise, the user may now remove the separator module 800 (or alternatively the plenum module 1100 in some embodiments) by sliding it rearward along the rails 204 and 206, to unlock the hooks 292 and 294 from the slots 808 and 810 at which point the separator module 800 (or plenum module 1100) may be removed by lifting it vertically upward off the rails 204 and 206 and out of the chassis 200.

The structural design of the present embodiment also lends itself to equally speedy and simple reassembly, by reversing the above process. To reassemble the trimming machine 100, the user may first lower the separator module 800 (or plenum module 1100) into the chassis 200, allowing the hooks 292 and 294 to pass through the slots 808 and 810, until the plates 804 and 806 are resting on the rails 204 and 206 of the chassis. The user may then slide the separator module 800 forward along the rails in the chassis to lock the hooks 292 and 294 in engagement with the slots 808 and 810.

The user may then lower the fan blade housing module 700 into the chassis, with its top plates 702 and 704 resting on the rails 204 and 206 of the chassis. The user may then slide the fan blade housing module 700 forward along the rails to abut against the separator module 800 (or plenum module 1100).

The user may then lower the fan motor housing 600 into the chassis 200, with its top plates 608 and 610 resting on the rails 204 and 206 of the chassis, allowing the hooks 212 and 214 to pass through the slots 616 and 618, until the plates 608 and 610 are resting on the rails 204 and 206. The user may then slide the fan motor housing 600 forward in the chassis along the rails, to lock the hooks 212 and 214 in engagement with the slots 616 and 618. Finally, the user may push downward on the handle 628, to force the roller bearings 632 and 634 into loaded engagement with the fourth upper crossbar 254. This action tends to push the fan motor module 600 forward in the chassis along the rails 204 and 206, causing the fan motor module 600 to bear against the fan blade housing module 700, which in turn bears against the separator module 800, and also firmly locks the fan motor module 600 and the separator module 800 in hooked engagement with the chassis.

To install the removable trimming module 300 in the chassis 200, the user simply lowers the trimming module into the chassis until the legs 302 and 304 of the trimming module 300 are squarely contained within the retention guides 296, 297, 298 and 299 defined at the corner ends of the rails 204 and 206, with each one of the legs 302 and 304 spanning and being supported by both of the rails 204 and 206.

To install the removable power pack module 500 in the trimming module 300, the user simply lowers the power pack module into the trimming module until the front and rear plates 504 and 506 are resting on the upper surfaces of right-side portions of the legs 302 and 304 of the trimming module. This completes the assembly of the trimming machine 100, and the fan motor 636 and the power pack module 500 may be connected to an external power source for operation of the trimming machine.

### Tandem Connection

Referring to FIGS. 2A, 9, 10 and 16A-C, in this embodiment the plant trimming machine 100 advantageously includes an interconnection system, configured to facilitate tandem (in series) connections with other plant trimming machines.

In this embodiment, the interconnection system includes a frame connector extending from a frame of the plant trimming machine, and an alignment mechanism adjustable to alter a height of the frame to align the frame connector with a complementary frame connector of an adjacent plant trimming machine.

More particularly, in this embodiment the frame connector includes a connection plate extending from and fixed relative to the frame of the plant trimming machine. More particularly still, in this embodiment the connection plate includes the jack plate 278, which extends from and is fixed relative to the chassis 200 of the plant trimming machine 100. Also in this embodiment, the alignment mechanism includes the jack 280, configured to adjust a height of the frame of the plant trimming machine 100. In this embodiment, the jack 280 is a worm screw jack, and is adjustable to alter the height of the chassis 200 on the side of the jack 280, to align the jack plate 278 with a complementary frame connector of an adjacent plant trimming machine.

In this embodiment, the connection plate includes at least one keyhole defined through the connection plate, and configured to receive at least one corresponding key of the complementary frame connector of the adjacent plant trimming machine. More particularly, in this embodiment the keyhole includes first and second keyholes 285 and 287 defined through the jack plate 278, configured to receive corresponding connection keys 288 and 290 of an interconnection system of another adjacent plant trimming machine 100.

In this embodiment, the keyholes 285 and 287 defined through the jack plate 278 are non-cylindrical. In this embodiment, in the adjacent trimming machine, the corresponding connector includes the keys 288 and 290, which in this embodiment are non-cylindrical knobs. When the frame of the plant trimming machine 100 is aligned with the frame of the adjacent plant trimming machine, each of the knobs 288 and 290 of the adjacent plant trimming machine is rotatable between at least an unlocked angular position in which the knob is angularly aligned with and fits through a corresponding one of the keyholes 285 and 287, and a locked angular position in which the knob is angularly misaligned with the corresponding keyhole 285 or 287 to prevent the knob from travelling through the keyhole.

In this embodiment, to connect the plant trimming machine 100 in tandem (in series) with another plant trimming machine, it is relatively easy to achieve horizontal alignment of the two machines because they are both on wheels and can easily be moved translationally and rotationally in a horizontal plane parallel to the ground. However, the machines will still need to be vertically aligned, to allow the output of one machine's tumbler to become the output to the next tumbler in series, while preventing spillage.

To achieve such vertical alignment in the present embodiment, with the two machines horizontally aligned, the user turns the actuator 1628 clockwise to raise the jack plate 278 of the trimming machine 100, until the jack plate 278 has risen to a greater height above ground than that of the connection knobs 288 and 290 of the adjacent trimming machine. The plant trimming machine 100 is then wheeled closer to the adjacent plant trimming machine until the keyholes 285 and 287 of the jack plate 278 of the plant trimming machine 100 are directly above the connection knobs 288 and 290 of the adjacent plant trimming machine. The user then turns the knobs 288 and 290 until their non-cylindrical shape aligns with that of the keyholes 285 and 287 so that the knobs 288 and 290 can pass through the keyholes 285 and 287. The user then turns the actuator 1628 counter-clockwise to lower the jack plate 278 until it abuts against the lower rear crossbar 282 of the adjacent plant trimming machine, blocking its further downward travel. The user then rotates the knobs 288 and 290 until they can no longer pass through the keyholes 285 and 287.

In this embodiment, the adjacent trimming machine includes an upstream trimming machine, and the frame connector includes an input connector configured to connect to a complementary output connector of the upstream trimming machine. Alternatively, or in addition, the frame connector may include an output connector configured to connect to a complementary input connector of a downstream trimming machine.

In this embodiment, trimming machine includes first and second frame connectors, with the first frame connector including the connection plate at the front end of the machine 100, and the second frame connector extending from the frame at an opposite end than the first frame connector (in this case the rear end), wherein the second frame connector is identical to the complementary frame connector of the adjacent trimming machine to which the first frame connector of the trimming machine is configured to connect.

Although the frame connector has been described above as comprising the connection plate at the front end of the trimming machine 100, alternatively, the frame connector may include a complementary connection key, such as the keys 288 and 290 including knobs as described above in connection with the rear end of the trimming machine 100, engageable with keyholes of a complementary connection plate of an adjacent trimming machine identical to the complementary connection plate described above. In other embodiments, the connector roles are reversed, with a male connector such as one or more connection keys at the front (input) end of the machine, and a female connector such as a connection plate at the rear (output) end of the machine. Alternatively, other types of tandem connection mechanisms may be substituted.

### Operation

During operation of the plant trimming machine 100, the tumbler motor 518 drives the tumbler 2002 in a clockwise direction as seen from the front of the machine 100, while the reel motor 516 drives the helical bladed cutting reel 1902 in a counter clockwise direction as seen from the front of the machine. The fan motor 636 spins the fan blades 644 to apply suction in the vicinity of the tumbler 2002, knife blade 2208 and cutting reel 1902. Plant material to be trimmed is continuously fed into an input hopper chute at the front of the machine, from which it enters the front of the rotating tumbler 2002. The machine 100 is slightly elevated at its front end so that gravity tends to propagate the plant material axially through the tumbler toward the rear of the machine as the tumbler rotates. As the plant material propagates through the tumbler, leaf material protrudes through the slots of the tumbler 2002 in the vicinity of the knife blade 2208, where the protruding leaf material is trimmed off by the scissor action of the helical cutting reel blades 1906 bearing against the knife blade 2208 as they spin. The suction generated by the fan motor 636 sucks the trimmed plant material away from the tumbler, into the separator module (if provided).

### Adjustable Airflow Choke

If desired, any of the embodiments described herein may be supplemented with an adjustable choke mechanism to adjust airflow within the trimming machine.

For example, referring to FIGS. 11A-C, the plenum module 1100 may be equipped with an adjustable baffle 1102 configured to adjustably control airflow through an airflow opening 1104 of the plenum module 1100. In this embodiment, the baffle 1102 is connected to a lever 1106 in fixed relationship, using a tight-fitting dowel 1112, such that the baffle 1102 does not rotate about the axis of the dowel 1112 relative to the lever 1106. The baffle 1102 is installed in the plenum module 1100 with the dowel 1112 positioned in a slot 1108 defined in the plenum module 1100, and another dowel 1114 positioned in another slot (not shown) of the plenum module opposite the slot 1108. A lower end of the lever 1106 (opposite the dowel 1112) extends through an airflow adjustment grating 1110, which enables a user to adjust airflow by moving the lever 1106 among a plurality of available positions defined in the airflow adjustment grating 1110. For example, the embodiment shown in FIG. 11B has four pre-defined airflow settings, and FIG. 11B illustrates the highest choke (least airflow) of the four available settings. To increase airflow in the trimming machine, the user may rotate the lever counter-clockwise and lock it into one of the other less restrictive settings, to rotate the baffle 1102 in a counter-clockwise direction in unison with the lever 1106, and to thereby increasingly widen the effective size of the airflow opening 1104, allowing greater airflow in the trimming machine 100.

Advantageously, the adjustable baffle, if present in a given embodiment, allows for adjustable airflow control through the trimming machine, in order to adapt to varying moisture levels of the plant material being trimmed. For example, the optimum airflow for dry plant material is typically less than optimal for wet plant material, and conversely, the optimum airflow for wet plant material may be excessive for dry plant material and may even result in shredding or other damage to the desired plant material. Whereas conventional machines typically have a single airflow inlet for all purposes, embodiments of the present disclosure having an adjustable baffle can adjust the airflow rates through the trimming machine as needed to adapt to varying moisture levels of plant material.

Although the adjustable choke mechanism has been described in connection with an embodiment that has a plenum module 1100 rather than a separator module, such a choke mechanism may also be provided as part of the separator module 800, or elsewhere in the airflow pathways of the trimming machine 100.

### Other Alternatives

Referring back to FIGS. 17A-18 and 23, in one simplified alternative embodiment, the helical pan assembly 2300 may be omitted. The roller cams 2302 and 2304, as well as the slots in the front and rear plates 2306 and 2308 of the helical pan assembly, may instead be moved to the unibody 1700.

Referring back to FIGS. 17A-18 and 24, in another simplified alternative embodiment, the brush assembly 2400 attaches only to the unibody 1700.

In addition to the embodiments described above, it is contemplated that any one or more features of any particular embodiment may be combined with any one or more features of any other embodiment, except features that have been explicitly described above as being mutually exclusive.

More generally, while specific embodiments of the present disclosure have been described and illustrated, such embodiments should be considered illustrative of the present disclosure only and not as limiting the present disclosure as defined by the accompanying claims.

1. A bed knife assembly for a trimming machine, the bed knife assembly comprising:
a knife holder; and
a knife blade comprising a secured portion secured within the knife holder, and a flexible unsecured portion extending outward from the knife holder by a sufficient distance to permit the flexible unsecured portion of the knife blade to flex during operation;
wherein the knife blade is pre-loaded with a sufficient pre-load force, applied between the bed knife assembly and a helical-bladed cutting reel of the trimming machine, to deform the knife blade.

2. The bed knife assembly of claim 1, wherein the pre-load force deforms the knife blade to bend at least partly into a cylindrical region within which the helical-bladed cutting reel spins.

3. The bed knife assembly of claim 1, wherein the flexible unsecured portion of the knife blade extends outward at least three quarters of an inch from the knife holder.

4. The bed knife assembly of claim 1, wherein the flexible unsecured portion of the knife blade extends outward at least one inch from the knife holder.

5. The bed knife assembly of claim 1, wherein the knife holder comprises first and second mounting tabs at opposite ends of the knife holder, each of the mounting tabs extending longitudinally beyond a respective opposite end of the flexible unsecured portion of the knife blade and being configured to engage in respective first and second mounting slots of the trimming machine.

6. The bed knife assembly of claim 4, wherein the knife holder includes a base and a cap between which the secured portion of the knife blade is secured, and wherein each of the mounting tabs is integrally formed with at least one of the base and the cap.

7. The bed knife assembly of claim 1, wherein the knife holder includes a base and a cap between which the secured portion of the knife blade is secured, and wherein the knife blade is welded between the base and the cap by capacitor discharge welding.

8. The bed knife assembly of claim 1, wherein the knife holder includes a base and a cap between which the secured portion of the knife blade is secured, and wherein each of the base and the cap comprises a stainless steel alloy.

9. The bed knife assembly of claim 8, wherein the knife blade comprises a second stainless steel alloy different than the stainless steel alloy of the base and the cap.

10. A trimming machine comprising the bed knife assembly of claim 1, and further comprising a removable power pack assembly configured to rest on the bed knife assembly to secure the bed knife assembly abutting the helical-bladed cutting reel with the pre-load force applied therebetween.

11-66. (canceled)
